(19) United States
(12) Patent Application Publication
(10) Pub. No.: US 2016/0379206 A1
(43) Pub. Date: Dec. 29, 2016

(54) METHOD FOR PAYMENT AND ELECTRONIC DEVICE PERFORMING THE SAME

(71) Applicant: Samsung Electronics Co., Ltd., Suwon-si (KR)

(72) Inventors: Yang Soo LEE, Yongin-si (KR); Su Young PARK, Uiwang-si (KR); Sun Kee LEE, Seongnam-si (KR); Dae Haeng CHO, Suwon-si (KR); Sung Hyuk SHIN, Seongnam-si (KR)

(21) Appl. No.: 15/171,397

(22) Filed: Jun. 2, 2016

(30) Foreign Application Priority Data
Jun. 24, 2015 (KR) 10-2015-0090064
Sep. 8, 2015 (KR) 10-2015-0126760

(51) Int. Cl. G06Q 20/32

(52) U.S. Cl. CPC G06Q 20/3278; G06Q 20/3229; G06Q 20/3226

(57) ABSTRACT

An electronic device that makes a payment with an external payment device includes a power module configured to power the electronic device is provided. The electronic device includes a memory configured to store first payment information that accompanies a user authentication and second payment information that does not accompany the user authentication, a near-field wireless communication module configured to send the first payment information or the second payment information stored in the memory to the external payment device, and a processor configured to obtain power information of the power module, to set the memory such that the first payment information is sent to the external payment device if a value corresponding to the power information is greater than or equal to a power value, and to set the memory such that the second payment information is sent to the external payment device if the value corresponding to the power information is less than the power value.

### CROSS-REFERENCE TO RELATED APPLICATION(S)

This application claims the benefit under 35 U.S.C. §119(a) of a Korean patent application filed on Jun. 24, 2015 in the Korean Intellectual Property Office and assigned Serial number 10-2015-0090064, and of a Korean patent application filed on Sep. 8, 2015 in the Korean Intellectual Property Office and assigned Serial number 10-2015-0126760 the entire disclosure of each of which is hereby incorporated by reference.

### TECHNICAL FIELD

The present disclosure relates to a mobile payment method and an electronic device performing the same.

### BACKGROUND

An electronic device is implemented in various forms and includes, for example, a smartphone that a user carries, a wearable device that is attached to a part of the body of a user, or the like. Due to the development of an information technology (IT) technology, the electronic device has significantly superior functions and provides a user with various functions. The electronic device provides a user with a network-based communication service such as a multimedia service (e.g., a music service, a video service, or a digital broadcast service), a call service, a wireless Internet service, a short message service (SMS), a multimedia messaging service (MIMS), or the like.

Nowadays, financial technology (also known as “Fin Tech”) that is a combination of a finance technology and the IT technology gets attention. The financial technology (“fin-tech”) evaluated as the financial paradigm shift extends its boundary to an off-line finance service, and the building service of a finance platform as well as an on-line finance service according to the related art.

For example, manufacturers of electronic devices make various efforts to the development of the electronic devices, the building of a payment platform, and the like for realizing the fin-tech through the cooperation of a credit card company or a bank.

An electronic device makes a payment through the fin-tech and exchanges finance information with a customer. For example, the electronic device exchanges information associated with a cash transaction with an external device by using a communication unit (or modules).

When sending or receiving the information associated with a cash transaction, the electronic device authenticates a user. For example, an electronic device that makes a payment about goods or services through a communication unit authenticates a user through an embedded security authentication unit (e.g., a fingerprint authentication module) and makes a payment based on the authentication.

The electronic device receives power from a battery having a limited capacity and makes the payment using the power. For example, in the case where the battery is discharged, it is difficult for the electronic device to drive the embedded security authentication unit. As a result, a user experiences any inconvenience because the electronic device does not make a payment when the battery is discharged.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of making a mobile payment with an external payment device by using an electronic device even though an embedded battery does not have power enough to perform a user authentication or the power is turned off and an electronic device performing the same.

In accordance with an aspect of the present disclosure, an electronic device that makes a payment with an external payment device is provided. The electronic device includes, for example, a power module configured to power the electronic device, a memory configured to store first payment information that accompanies a user authentication and second payment information that does not accompany the user authentication, a near-field wireless communication module configured to send the first payment information or the second payment information stored in the memory to the external payment device, and a processor configured to obtain power information of the power module, to set the memory such that the first payment information is sent to the external payment device if a value corresponding to the power information is greater than or equal to a power value, and to set the memory such that the second payment information is sent to the external payment device if the value corresponding to the power information is less than the power value.

In accordance with another aspect of the present disclosure, an electronic device is provided. The electronic device includes, for example, a power module (e.g., a battery, or the like) configured to power the electronic device, a secure element (SE) configured to store first payment information using a user authentication and second payment information not using the user authentication, a processor configuring the second payment application stored in the SE to be in a condition in which a payment is possible if remaining power of a battery is less than or equal to a value, and a near-field wireless communication module configured to send payment data, which is based on the second payment application, to the external payment device.

In accordance with another aspect of the present disclosure, a payment method of an electronic device that makes a payment with an external payment device is provided. The payment method includes verifying remaining power of a battery included in the electronic device, configuring a payment application, which requires a user authentication, stored in a SE of the electronic device to be in a condition in which a payment is possible if the remaining power of the battery is less than or equal to a value, and sending payment data, which is based on the payment application configured to be in the condition in which a payment is possible, to the external payment device.

In accordance with another aspect of the present disclosure, in a non-transitory computer-readable recording medium having recorded thereon an instruction, the instruction, which is executed by at least one processor, causing the at least one processor to perform a method is provided. The method includes verifying remaining power of a battery included in the electronic device, configuring a payment application, which requires a user authentication, stored in a SE of the electronic device to be in a condition in which a payment is possible if the remaining power of the battery is less than or equal to a value, and sending payment data, which is based on the payment application configured to be in the condition in which a payment is possible, to an external device.

In accordance with another aspect of the present disclosure, an electronic device is provided. The electronic device includes a memory configured to store first payment information that accompanies authentication information and second payment information that does not accompany the authentication information, a near-field wireless communication module configured to send the first payment information or the second payment information to an external payment device, and a payment management module situated outside the near-field wireless communication module. The payment management module is configured to verify power information of a power module functionally connected with the electronic device, to send the first payment information to the external payment device through the near-field wireless communication module if the power information belongs to a first range, and to send the second payment information to the external payment device through the near-field wireless communication module if the power information belongs to a second range.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a situation in which an electronic device according to an embodiment of the present disclosure makes a payment with an external payment device;

FIG. 2 illustrates a block diagram of an electronic device according to an embodiment of the present disclosure;

FIGS. 3A to 3C illustrate flowcharts according to various embodiments of the present disclosure;

FIG. 4 illustrates a payment flowchart when a battery is removed, according to an embodiment of the present disclosure;

FIG. 5 illustrates an operation of an electronic device according to an embodiment of the present disclosure;

FIG. 6 illustrates an operation of an electronic device according to another embodiment of the present disclosure;

FIG. 7 illustrates a payment process using an electronic device according to an embodiment of the present disclosure;

FIG. 8 illustrates a payment process using an electronic device according to another embodiment of the present disclosure;

FIG. 9 illustrates a block diagram of an electronic device according to various embodiments of the present disclosure;

FIG. 10 illustrates a communication protocol between a plurality of electronic devices according to various embodiments of the present disclosure;

FIG. 11 illustrates an electronic device in a network environment according to various embodiments of the present disclosure; and

FIG. 12 illustrates a block diagram of a program module according to various embodiments of the present disclosure.

Throughout the drawings, it should be noted that like reference numbers are used to depict the same or similar elements, features, and structures.

### DETAILED DESCRIPTION

The following description with reference to accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, “a first user device” and “a second user device” indicate different user devices regardless of the order or priority. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP)) which performs corresponding operations by executing one or more software programs which are stored in a memory device.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include, for example, at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments of the present disclosure, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or an implantable type (e.g., an implantable circuit).

According to an embodiment of the present disclosure, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, a home automation control panel, a security control panel, TV boxes (e.g., Samsung HomeSync™, Apple TV™, or Google TV™), game consoles (e.g., Xbox™ and PlayStation™), electronic dictionaries, electronic keys, camcorders, or electronic picture frames.

According to another embodiment of the present disclosure, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). According to various embodiments of the present disclosure, the electronic device may be one of the above-described devices or a combination thereof. An electronic device according to an embodiment may be a flexible electronic device. Furthermore, an electronic device according to an embodiment of the present disclosure may not be limited to the above-described electronic devices and may include other electronic devices and new electronic devices according to the development of technologies.

Hereinafter, electronic devices according to various embodiment of the present disclosure will be described with reference to the accompanying drawings. The term “user” used herein may refer to a person who uses an electronic device or may refer to a device (e.g., an artificial intelligence electronic device) that uses an electronic device.

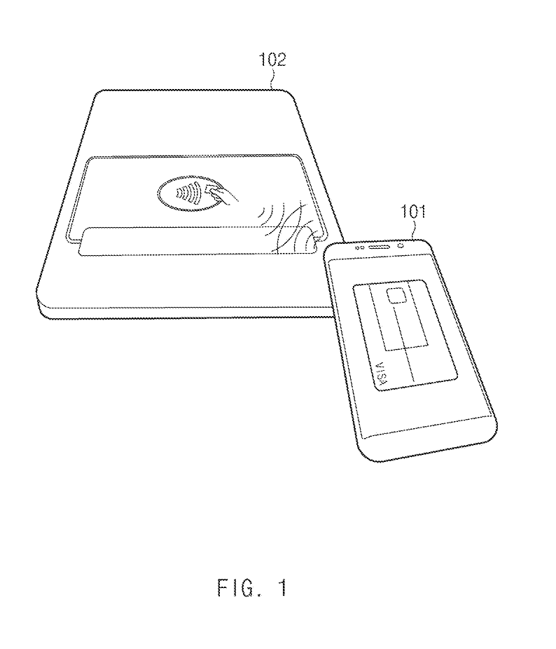

FIG. 1 illustrates a situation in which an electronic device according to an embodiment of the present disclosure makes a payment with an external payment device.

Referring to FIG. 1, an electronic device 101 may interact with an external payment device 102 based on a near-field wireless communication manner. For example, the electronic device 101 may correspond to a smartphone including a near field communication (NFC) module, and the external payment device 102 may correspond to a PoS terminal including a NFC module.

If the electronic device 101 approaches the external payment device 102 to be closer than a designated distance (e.g., about 10 cm), the external payment device 102 may communicate with, for example, the electronic device 101 based on designated frequency (e.g., 13.56 MHz). According to an embodiment of the present disclosure, the electronic device 101 may communicate with the external payment device 102 by using an embedded payment module (e.g., a NFC module). According to an embodiment of the present disclosure, the electronic device 101 may receive power from the external payment device 102 by using an embedded NFC module based on an electromagnetic induction method. The electronic device 101 may communicate with, for example, the external payment device 102 by using the received power.

For example, the electronic device 101 and the external payment device 102 may communicate with each other based on a designated protocol, establishing a security channel for a payment process. The electronic device 101 may send payment data to the external payment device 102 through the established security channel. For example, the external payment device 102 may communicate with a card company and/or a finance institution based on the received payment data through an external network (e.g., a PoS system network), making a payment.

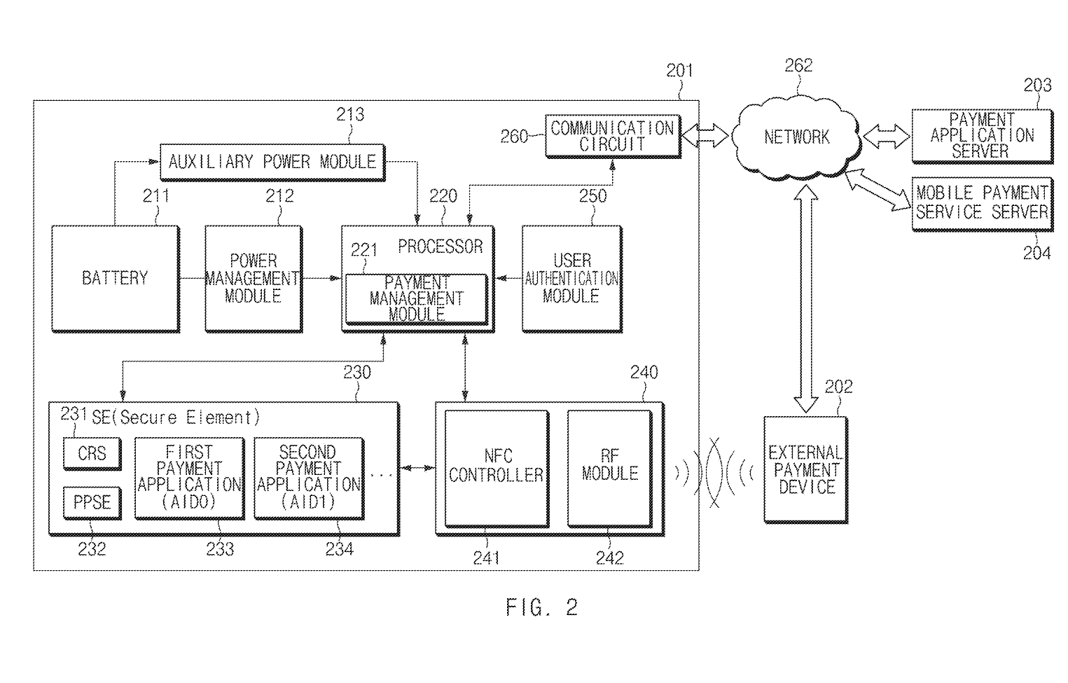

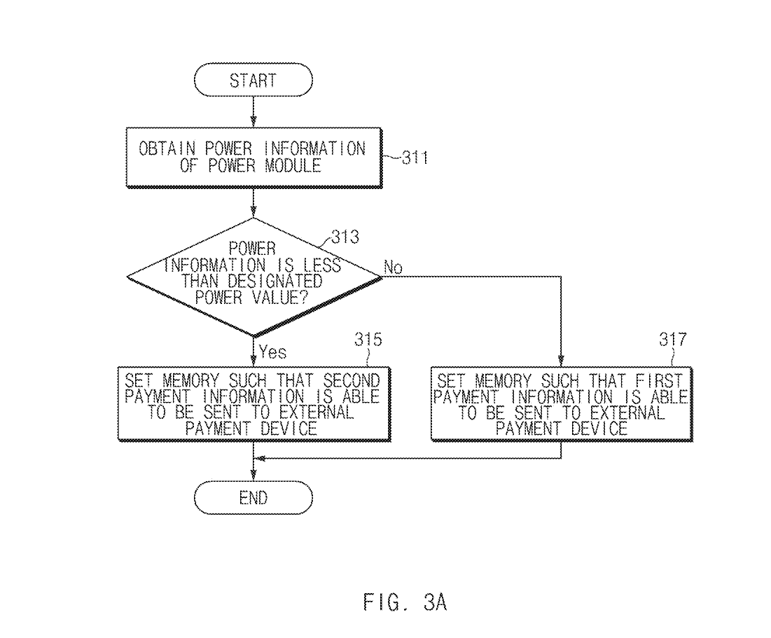

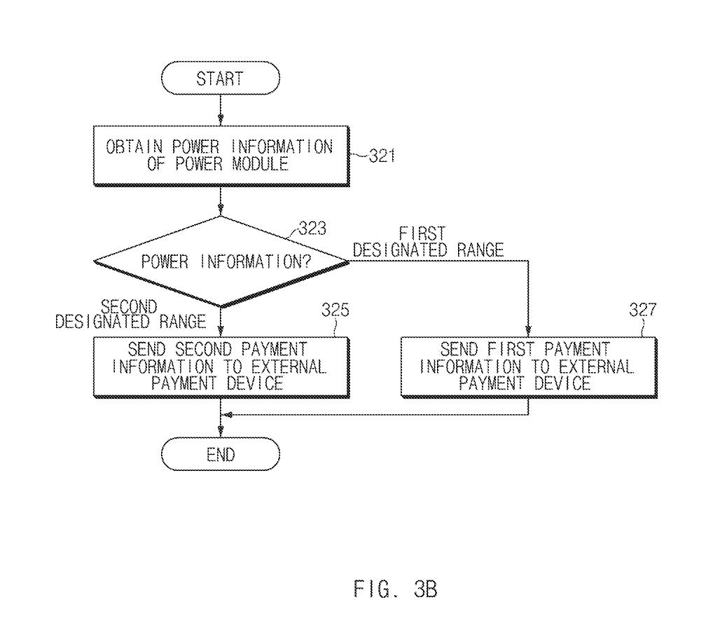

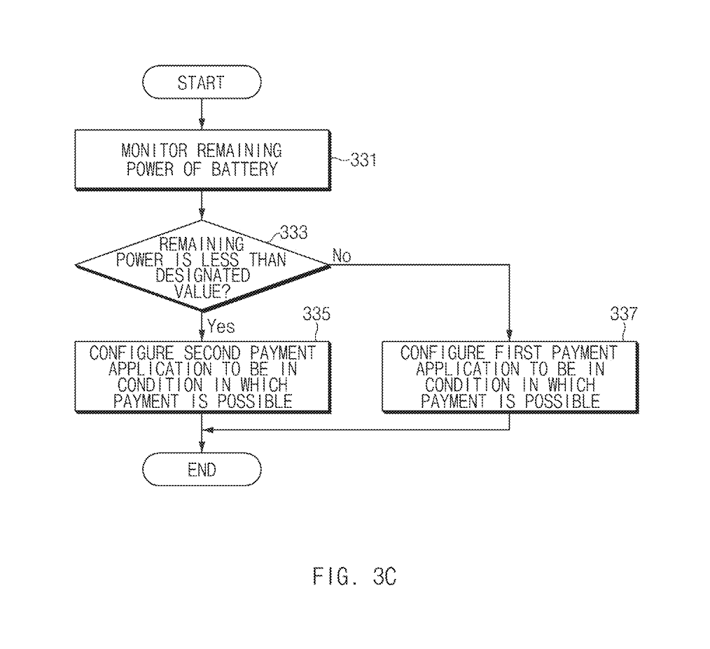

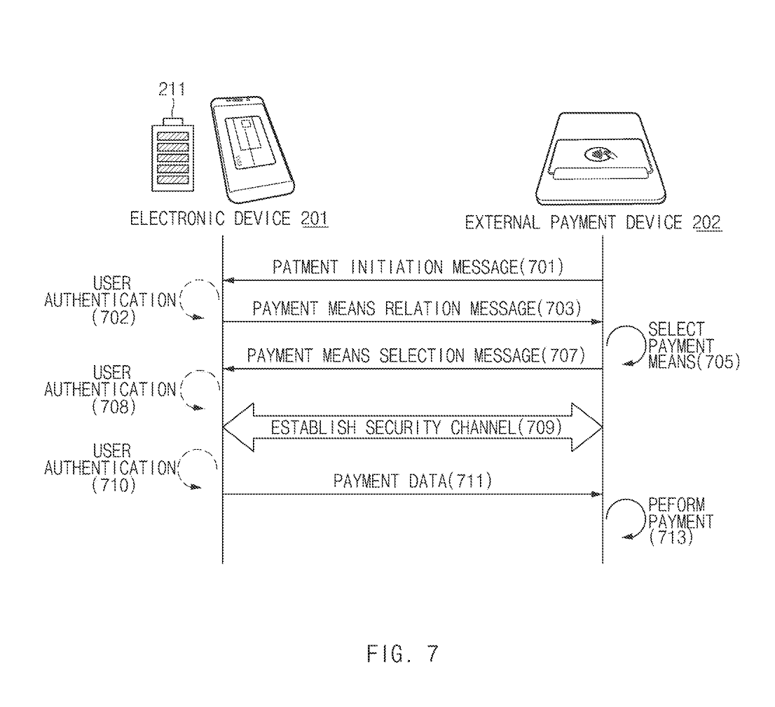

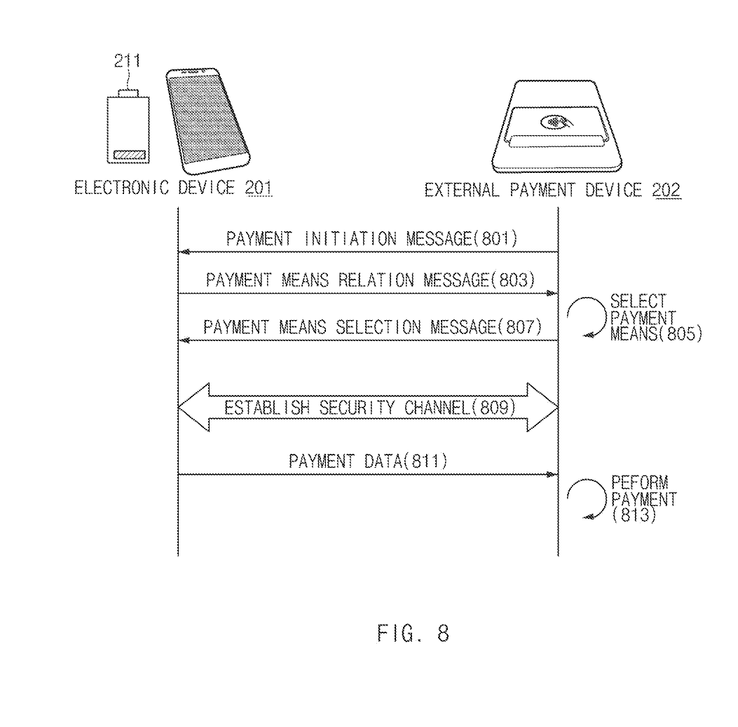

Below, elements of the electronic device 101 according to an embodiment of the present disclosure may be described with reference to FIG. 2. The payment method according to an embodiment of the present disclosure may be described with reference to FIGS. 3A to 3C, and FIGS. 4 to 6. Moreover, the detailed interaction and the payment process between the electronic device 101 and the external payment device 102 may be described with reference to FIGS. 7 and 8.

FIG. 2 is a block diagram illustrating an electronic device according to an embodiment of the present disclosure.

Referring to FIG. 2, the electronic device 201 that makes a payment with the external payment device 202 may include, for example, a battery 211, a power management module 212, an auxiliary power module 213, a processor 220, a secure element (SE) 230, a near-field wireless communication module 240, a user authentication module 250, and/or a communication circuit 260. For example, the electronic device 201 and the external payment device 202 may correspond to the electronic device 101 and the external payment device 102 illustrated in FIG. 1, respectively.

The battery 211 may power, for example, each of elements included in the electronic device 201. The battery 211 may correspond to, for example, a secondary cell such as a lithium-ion battery. According to an embodiment of the present disclosure, the battery 211 may be used as a “power module”. For example, the battery 211 may power each of elements included in the electronic device 201 through the power management module 212.

The power management module 212 may manage, for example, a charge/discharge operation of the battery 211 and/or the auxiliary power module 213. According to an embodiment of the present disclosure, the power management module 212 may be implemented with a hardware chip that sends power information of the battery 211 to the processor 220 or may be implemented with at least a part of the processor 220. Moreover, for example, the power management module 212 and/or the processor 220 may include an application having an application programming interface (API) that accesses the battery 211. The application may provide the power information to an operating system (OS) or another application such that the power state of the battery 211 is provided to a user.

According to an embodiment of the present disclosure, the power management module 212 may monitor the remaining capacity of the battery 211, sending power information of the battery 211 to the processor 220 (or the payment management module 221 of the processor 220). For example, the power management module 212 may provide the power information in response to the request of the processor 220. Moreover, for example, the power management module 212 may periodically provide the power information to the processor 220. Alternatively, in the case where the remaining capacity of the battery 211 corresponds to at least one threshold value (e.g., 5%, 10%, 20%, . . . , 80%, 90%, or the like), the power management module 212 may provide the power information of the battery 211 to the processor 220. For example, in the case where the remaining power of the battery 211 is smaller than or equal to 10%, the power management module 212 may notify the processor 220 of the power information of the battery 211. In this case, the processor 220 may notify a user that the remaining capacity of the battery 211 is less than or equal to a designated threshold value, through an output module (e.g., display (not shown), or the like) functionally connected to the processor 220.

For example, the auxiliary power module 213 may power each of elements included in the electronic device 201 through the power management module 212. For example, the auxiliary power module 213 may preparatorily power at least one element (e.g., the processor 220, the SE 230, or the like) included in the electronic device 201. For example, in the case where the battery 211 is removed therefrom or is suddenly discharged, the auxiliary power module 213 may temporarily supply power to a designated element (e.g., the processor 220, the SE 230, or the like) of the electronic device 201. The designated element (e.g., the processor 220, the SE 230, or the like) may execute a function by using the power supplied from the auxiliary power module 213. According to an embodiment of the present disclosure, the function that the designated element executes may correspond to a function in which the processor 220 changes an application list, which is included in the SE 230, for a payment. For example, the application list, which is included in the SE 230, for a payment may include an application identifier (AID) list. For example, the auxiliary power module 213 may be implemented in the form of a capacitor, a secondary cell, or the like.

For example, the processor 220 may receive a command from various elements included in the electronic device 201, may decode the received command, and may perform an operation or a data processing according to the decoded command. For example, the processor 220 may correspond to an AP that is separately implemented with the near-field wireless communication module 240. The processor 220 may perform a mobile payment service application (e.g., Samsung pay application) as a platform for performing a payment method according to various embodiments of the present disclosure.

The processor 220 according to an embodiment may execute a payment management module application (hereinafter, referred to as “payment management module 221”). For example, the payment management module 221 may be implemented by an AP. For example, the payment management module 221 may be performed in a trusted execution environment (TEE) or a rich execution environment (REE) that is specified and defined at a global platform (GP) being a standard group. Moreover, for example, the payment management module 221 may be performed based on a trusted platform module (TPM) specified at a trusted computing group (TCG).

The processor 220 according to an embodiment may perform the payment method according to various embodiments of the present disclosure through the payment management module 221. In the payment method according to various embodiments described in the present disclosure, each operation of the processor 220 may be understood as an execution operation of the payment management module 221.

According to an embodiment of the present disclosure, the payment management module 221 may include an application having an API that accesses the SE 230. The payment management module 221 may include, for example, an application having an API that accesses various types of SE (e.g., an embedded SE (eSE), a universal integrated chip card (UICC), an embedded UICC (eUICC), a micro secure digital (SD) card, a subscriber identification module (SIM) card, or the like. a payment management module 221 that accesses the various types of SE may be used as various names and may be not limited to the name referred to as “payment management module”. According to an embodiment of the present disclosure, the payment management module 221 may correspond to a contactless registry services (CRS) updater for a CRS 231 included (e.g., stored or installed) in the SE 230 to be described below.

The SE 230 may correspond to, for example, a protected storage area included in the electronic device 201. For example, the SE 230 may be connected with the processor 220 through the near-field wireless communication module 240 or may be directly connected with the processor 220.

According to an embodiment of the present disclosure, the SE 230 may send and receive a variety of information associated with a payment by communicating with the external payment device 202 (e.g., a PoS terminal or a credit card payment terminal) through the near-field wireless communication module 240. For example, even though the SE 230 does not receive power from the battery 211 or the auxiliary power module 213, the SE 230 may activate various applications stored in the SE 230 based on energy supplied from the near-field wireless communication module 240. For example, the SE 230 may exchange a variety of information associated with a payment with the external payment device 202 based on operations of the activated applications.

The SE 230 according to an embodiment of the present disclosure may store a CRS 231, a proximity payment system environment (PPSE) 232, a first payment application 233, and a second payment application 234.

According to various embodiments of the present disclosure, the SE 230 may be simply used as a “memory” in view of the fact that the SE 230 stores an application, payment information, and/or payment data. The memory may include at least one of an eSE, a UICC, an eUICC, a micro SD card, or a SIM card. For example, each of the various types of memories may store a configuration, which corresponds to the CRS 231, PPSE 232, the first payment application 233, and/or the second payment application 234, as various types or names.

According to an embodiment of the present disclosure, the CRS 231 and the PPSE 232 may be implemented with one application. Moreover, for example, in the various types of memories that are described above, a module that executes functions of the CRS 231 and the PPSE 232 may be implemented with one element.

The CRS 231 may execute, for example, an interface function for accessing an application (e.g., the PPSE 232, the first payment application 233, the second payment application 234) stored in the SE 230 from an external device (e.g., the processor 220 and the near-field wireless communication module 240). For example, in the case where the electronic device 201 may make a payment with the external payment device 202, the near-field wireless communication module 240 may access payment data of the first payment application 233 or the second payment application 234 stored in the SE 230 through the CRS 231. According to an embodiment of the present disclosure, the processor 220 may perform the registration, modification, and cancellation of an AID list of the PPSE 232 included (e.g., stored or installed) in a memory (e.g., the SE 230) through the CRS 231.

According to an embodiment of the present disclosure, the CRS 231 may set a memory (e.g., the SE 230) such that the first payment data by the first payment application 233 or the second payment data by the second payment application 234 is sent to the external payment device 202 based on whether a value corresponding to power information (e.g., remaining power, or the like) of a power module (e.g., the battery 211) is greater than or equal to a threshold value or is less than the threshold value.

According to another embodiment of the present disclosure, the CRS 231 may set the memory such that at least some of functions of a payment application stored in a memory are activated for execution of a payment function, based on whether a value corresponding to power information (e.g., remaining power, or the like) of a power module (e.g., the battery 211) is greater than or equal to a threshold value or is less than the threshold value. for example, if the remaining power of the battery 211 is less than or equal to a designated value, the CRS 231 may activate at least some of functions of a payment application stored in the SE 230 to a condition in which a payment is possible. The payment data of the activated payment application may be sent, for example, to the external payment device 202 through the near-field wireless communication module 240.

The PPSE 232 may include, for example, the AID list and/or priority information. The AID list may correspond to, for example, the set of the identifier AID of a payment application used at a real payment (activated as a condition in which a payment is possible). According to an embodiment of the present disclosure, the AID may correspond to a digit or a letter for distinguishing the payment application. For example, ‘0’ may be allocated to the AID of the first payment application 233 (AID 0), and ‘1’ may be allocated to the AID of the second payment application 234 (AID 1). As such, different payment applications may have different AIDs, respectively. In the case where a plurality of AIDs is registered in the AID list, the priority information may correspond to, for example, information indicating the payment priority of the AIDs.

Each of the first payment application 233 and the second payment application 234 may correspond to, for example, a payment application corresponding to each credit card account issued from a card management server of a card company or may correspond to a payment application corresponding to a financial account assigned from a finance server of a bank. The payment applications may be implemented using a Java™ programming language. In this case, the payment application may be used as a payment applet.

Each of the first payment application 233 and the second payment application 234 may include, for example, various data (i.e., payment data) for making a payment with the external payment device 202. For example, the payment data may include at least one of a primary account number (PAN) corresponding to card information connected with a financial account, at least a part of a token, of which the security is improved, which replacing the PAN, and/or a cryptogram. For example, the token may basically be static information corresponding to card information (e.g., PAN). In the present disclosure, payment data of the first payment application 233 may be used as the first payment information, and payment data of the second payment application 234 may be used as the second payment information.

According to an embodiment of the present disclosure, the first payment application 233 may correspond to a payment application requiring a user authentication (e.g., fingerprint authentication, or the like) during a payment process. The second payment application 234 may correspond to a payment application not requiring a user authentication during a payment process. For example, in the case where the electronic device 201 makes a payment with the external payment device 202 by using the first payment application 233, the electronic device 201 may normally make a payment only after a user authentication is completely performed through the user authentication module 250. For example, in the case where the electronic device 201 makes a payment with the external payment device 202 using the second payment application 234, the electronic device 201 may normally make a payment even though a user authentication is not performed.

The near-field wireless communication module 240 may correspond to, for example, a NFC module. For example, in the present disclosure, the near-field wireless communication module 240 may correspond to a NFC module. However, embodiments disclosed herein may not be limited thereto. The near-field wireless communication module 240 may include an NFC controller 241 and a radio frequency (RF) module 242 controlled by the NFC controller 241. The RF module 242 may send and receive, for example, data and/or power based on an electromagnetic induction manner. For example, the near-field wireless communication module 240 may be implemented with a module that is independent of the processor 220 and may exchange information (e.g., a message) associated with various types of payments with the processor 220 and/or the SE 230.

The near-field wireless communication module 240 according to an embodiment may establish a security channel with the external payment device 202 through the RF module 242 based on the AID registered in the AID list of the PPSE 232 of the SE 230. For example, the near-field wireless communication module 240 may send payment data (e.g., payment information) based on a payment application to the external payment device 202 through the established security channel.

For example, the user authentication module 250 may obtain authentication information from a user and may check (or compare) the authentication information with the previously registered authentication information. Accordingly, the user authentication module 250 may determine whether a user inputting the authentication information is the previously registered user. For example, when performing the user authentication, the user authentication module 250 may use computing resource of the processor 220. The user authentication may include, for example, at least one of a fingerprint authentication, a personal identification number (PIN) authentication, or a biometric authentication. The biometric authentication may include, for example, an iris authentication, a vein authentication, a voice authentication, and the like.

The communication circuit 260 may establish, for example, a communication between the electronic device 201 and an external device (e.g., a payment application server 203 and a mobile payment service server 204). For example, the communication circuit 260 may be connected to a network 262 through a wireless communication or a wired communication, communicating with the external device.

The external payment device 202 (e.g., the external payment device 102) may include, for example, a near-field wireless communication module (e.g., an NFC communication module), establishing a security channel with the electronic device 201 (or the near-field wireless communication module 240 of the electronic device 201). The external payment device 202 may exchange information associated with a payment with the electronic device 201 through the security channel. Moreover, for example, the external payment device 202 may send and receive data and/or power based on an electromagnetic induction manner. The external payment device 202 may correspond to, for example, a PoS terminal provided at a credit card member store. The external payment device 202 may communicate with a card company and/or a finance institution through the network 262, making a payment.

The payment application server 203 may communicate with, for example, the electronic device 201, the external payment device 202, and/or the mobile payment service server 204 through the network 262. The payment application server 203 may include, for example, at least one server. For example, the payment application server 203 may include at least one of a server of a finance institution (e.g., card company, or the like) that approves or disapproves a payment approval request from the external payment device 202, a server that provides a payment application (e.g., the first payment application 233 or the second payment application 234) to the electronic device 201, a server (e.g., a token service provider (TSP)) that manages information of a token, a cryptogram, and the like associated with a payment application, or a server (e.g., a trusted service manager (TSM)) that manages payment records of each user account.

According to an embodiment of the present disclosure, the payment application server 203 may issue a token used at a payment process between the electronic device 201 and the external payment device 202. For example, the payment application server 203 may generate the token based on a bank identification number (BIN), and the like, providing the generated token to the electronic device 201. For example, the token may be encrypted by the payment application server 203 or may be provided to the electronic device 201 to be decrypted.

The payment application server 204 may communicate with, for example, the electronic device 201, the external payment device 202, and/or the payment application server 203 through the network 262. For example, a security channel may be established between the mobile payment server 204 and the payment application server 203. According to an embodiment of the present disclosure, the mobile payment server 204 may correspond to a server (e.g., Samsung pay server), which manages a mobile payment service application (e.g., Samsung pay application), as a platform for performing a payment method according to various embodiments of the present disclosure.

According to various embodiments of the present disclosure, the processor 220 may set the memory such that the state of a payment application stored in a memory (e.g., the SE 230) is changed to a condition in which a payment is possible or a condition in which a payment is impossible. According to an embodiment of the present disclosure, the processor 220 may configure the first payment application 233 or the second payment application 234 stored on the SE 130 to a condition in which a payment is possible or a condition in which a payment is impossible based on the selection of a user or internal logic.

According to an embodiment of the present disclosure, the processor 220 may change the state of a payment application to a condition in which a payment is possible or a condition in which a payment is impossible by changing the AID list of the PPSE 232 included (e.g., stored or installed) in the SE 230. For example, the processor 220 may register, modify, shift (in the SE 230), or discard the AID of a payment application in the AID list of the PPSE 232.

For example, if the AID of a payment application is registered in the AID list, a corresponding payment application may be configured to be in a condition in which a payment is possible. Moreover, for example, if the AID of a payment application in the AID list is discarded, a corresponding payment application may be configured to be in a condition in which a payment is impossible. Moreover, for example, if the AID of a payment application is included in the AID list of the PPSE 232 based on the modification or the shift of the AID of a payment application, the payment application may be configured to be in a condition in which a payment is possible or a condition in which a payment is impossible.

Moreover, according to various embodiments of the present disclosure, the processor 220 may activate at least some of functions of a payment application (e.g., the first payment application 233 or the second payment application 234) stored in a memory (e.g., the SE 230). Accordingly, the processor 220 may set the memory such that a payment is possible. For example, the processor 220 may load the payment application from the memory, activating the at least some of functions. Moreover, the processor 220 may configure, for example, the payment application to be in a condition, in which a payment is possible, based on the activation.

According to an embodiment of the present disclosure, the processor 220 may deactivate at least some of functions of a payment application. For example, the processor 220 may not load the payment application to the memory, activating the at least some of functions. Moreover, the processor 220 may configure, for example, the payment application to be in a condition, in which a payment is impossible, based on the deactivation.

According to an embodiment of the present disclosure, on the basis of the power information of the battery 211 obtained from the power management module 212, the processor 220 may configure a payment application stored in the SE 130 to be in a condition in which a payment is possible or a condition in which a payment is impossible.

For example, the processor 220 may configure a payment application stored in the SE 130 to be in a condition in which a payment is possible or a condition in which a payment is impossible based on power information of the battery 211 obtained from the power management module 212 and based on whether the remaining power of the battery 211 is greater than (or is greater than or equal to) a designated value, or whether the remaining power of the battery 211 is less than or equal to (or is less than) the designated value.

The designated value may be set, for example, based on a type of the electronic device 201, the state of the battery 211, and/or a user setting. For example, in the case where the electronic device 201 is a wearable device (e.g., a smart watch, or the like) in which a low-capacity battery is mounted, the designated value may be configured to be greater than a designated value of an electronic device in which a high-capacity battery is mounted. Besides, the designated value may be variously set based on, for example, the location or current time of the electronic device 201 according to a setting of a user.

For example, the case where the payment application is configured to be in a condition in which a payment is possible may include the case where the AID of the payment application is registered in the AID list of the PPSE 232 of the SE 230. The AID of the payment application may be registered in the AID list of the PPSE 232, and thus the payment application may be configured to be in a condition in which a payment is possible. As such, the electronic device 201 may exchange payment information (e.g., card information) of the payment application with the external payment device 202.

Moreover, for example, the case where the payment application is configured to be in a condition in which a payment is impossible may include the case where the AID of the payment application is not registered in the AID list of the PPSE 232 of the SE 230. If the AID of the payment application is not registered in the AID list of the PPSE 232, the payment application may be configured to be in a condition in which a payment is impossible. As the payment application is configured to be in a condition in which a payment is impossible, the electronic device 201 may not exchange the payment information of the payment application with the external payment device 202.

According to an embodiment of the present disclosure, in the case where the remaining power of the battery 211 is less than or equal to (or is less than) a designated value, the processor 220 may configure the second payment application 234 stored in the SE 230 to be in a condition in which a payment is possible. As illustrated above, the second payment application 234 may correspond to a payment application not requiring a user authentication during a payment process.

For example, the case where the remaining power of the battery 211 is less than or equal to (or is less than) a designated value (e.g., 5%, 10%, 20%, or the like) may include the case where the battery 211 has power of a rated power (or regular capacity) of actually 0%, the case where an electronic device is powered off, and the case where the battery 211 is removed from the electronic device 201.

For example, if the remaining power of the battery 211 is determined as being smaller than or equal to 10% of a rated power based on the power information obtained from the power management module 212, the processor 220 may control the CRS 231 to register the AID of the second payment application 234 in the AID list of the PPSE 232.

In particular, for example, if the remaining power of the battery 211 is smaller than or equal to 10% of a rated power, the processor 220 may send an AID change message for registering the AID of the second payment application 234 in the AID list of the PPSE 232 to the CRS 231 of the SE 230. The CRS 231 may register, for example, the AID of the second payment application 234 in the AID list of the PPSE 232 based on the AID change message, configuring the second payment application 234 to be in a condition in which a payment is possible. For example, the SE 230 (or the PPSE 232 thereof) may be set such that the second payment information (e.g., second payment data) of the second payment application 234 is sent to the external payment device 202.

According to various embodiments of the present disclosure, for example, the processor 220 may cancel the AID of the first payment application 233 from the AID list of the PPSE 232, configuring the first payment application 233 to be in a condition in which a payment is impossible and configuring only the second payment application 234 to be in a condition in which a payment is possible.

Moreover, according to various embodiments of the present disclosure, for example, in the case where the second payment application 234 is already in a condition in which a payment is possible because the AID of the second payment application 234 is registered in the AID list of the PPSE 232, the processor 220 may maintain a condition, in which a payment is possible, of the second payment application 234.

Meanwhile, according to an embodiment of the present disclosure, in the case where the remaining power of the battery 211 is greater than (or is greater than or equal to) a designated value (e.g., 5%, 10%, 20%, or the like), the processor 220 may configure the first payment application 233 stored in the SE 230 to be in a condition in which a payment is possible. As illustrated above, the first payment application 233 may correspond to a payment application requiring a user authentication during a payment process.

For example, if the remaining power of the battery 211 is determined as being greater than 10% of a rated power based on the power information obtained from the power management module 212, the processor 220 may control the CRS 231 to register the AID of the second payment application 233 in the AID list of the PPSE 232.

In particular, if the processor 220 determines that the remaining power of the battery 211 is greater than, for example, 10% of a rated power, the processor 220 may send, to the CRS 231 of the SE 230, an AID change message for registering the AID of the first payment application 233 in the AID list of the PPSE 232. The CRS 231 may register, for example, the AID of the first payment application 233 in the AID list of the PPSE 232 based on the AID change message, configuring the first payment application 233 to be in a condition in which a payment is possible. For example, the SE 230 (or the PPSE 232 thereof) may be set such that the first payment information (e.g., the first payment data) of the first payment application 233 is sent to the external payment device 202.

According to various embodiments of the present disclosure, for example, the processor 220 may cancel the AID of the first payment application 234 from the AID list of the PPSE 232, configuring the first payment application 234 to be in a condition in which a payment is impossible and configuring only the second payment application 233 to be in a condition in which a payment is possible.

Moreover, according to various embodiments of the present disclosure, in the case where the first payment application 233 is already in a condition in which a payment is possible because the AID of the first payment application 233 is registered in the AID list of the PPSE 232, the processor 220 may maintain, for example, a condition, in which a payment is possible, of the first payment application 233.

The AID of one payment application may be exclusively registered in the AID list of the PPSE 232 of the SE 230 according to an embodiment of the present disclosure. For example, as described above, a payment application of the AID exclusively registered in the AID list may be used as a default payment application. Moreover, the payment information (or payment data) of the default payment application may be used as, for example, default payment information (or default payment data).

For example, in the case where the remaining power of the battery 211 is less than or equal to (or is less than) a designated value, the payment management module 221 of the processor 220 may exclusively register the AID (i.e., AID 1) of the second payment application 234 in the AID list. As such, for example, the second payment application 234 may be designated as a default payment application, and the payment information of the second payment application 234 may be designated as default payment information.

Moreover, for example, in the case where the remaining power of the battery 211 is greater than or equal to (or is greater than) a designated value, the payment management module 221 of the processor 220 may exclusively register the AID (i.e., AID 0) of the first payment application 233 in the AID list. As such, for example, the first payment application 233 may be designated as a default payment application, and the payment information of the first payment application 233 may be designated as default payment information.

The designation of the default payment application, or the like may not be limited to the embodiment of the present disclosure. For example, the default payment application, or the like may be designated based on the selection or the setting of a user.

If the remaining power of the battery 211 is less than or equal to a designated value, the processor 220 according to an embodiment may notify a user that the remaining power of the battery 211 is less than or equal to the designated value and may require a user authentication from a user. After performing a user authentication through the user authentication module 250, the processor 220 may configure the second payment application 234 to be in a condition in which a payment is possible.

If a power supply by the battery 211 is interrupted, the processor 220 according to an embodiment may use power that the auxiliary power module 213 supplies. The case where the power supply by the battery 211 is interrupted may include, for example, the case where the battery 211 is removed from the electronic device 201, the case where the electronic device 201 is powered off, or the remaining power of a battery has power of a rated power of actually 0%. The processor 220 may configure, for example, the second payment application 234 to be in a condition, in which a payment is possible, based on power that the auxiliary power module 213 supplies.

According to an embodiment of the present disclosure, whether to need a user authentication during a payment process about a payment application may be set by the payment application server 203. For example, when the electronic device 201 installs and/or stores the payment application, the payment application server 203 may set whether to need a user authentication.

For example, one token of a variety of payment data to be included in the payment application may be controlled by the payment application server 203. For example, the payment application server 203 may activate, temporarily suspend, resume, or discard the token. Whether to need a user authentication about the token may be set at the payment application server 203. For example, as illustrated in Table 1, the payment application server 203 may store token setting information.

TABLE 1

| token ID | user ID | device ID | PAN | user authentication |
|---|---|---|---|---|
| #123A456 | xxxx | 1111 | 987 . . . 654 | O |
| #123X789 | xxxx | 1111 | 987 . . . 654 | X |
| #456A746 | xxxx | 1111 | 345 . . . 126 | O |
| #986X586 | xxxx | 1111 | 302 . . . 246 | X |

Referring to Table 1, for example, the payment application server 203 may correspond to and store a user ID, a device ID, a PAN, and whether to need a user authentication about each token ID of a payment application. For example, the token of which the token ID is “#123A456” may need a user authentication. Accordingly, in the case where the token of which the token ID is “#123A456” is provided to the electronic device 201, the token may be included in the first payment application 233. For example, the token of which the token ID is “#123X789” may not need a user authentication. Accordingly, in the case where the token of which the token ID is “#123X789” is provided to the electronic device 201, the token may be included in the second payment application 234.

According to an embodiment of the present disclosure, when the electronic device 201 provides card information (e.g., a PAN) to the payment application server 203 and receives and installs a corresponding payment application, the electronic device 201 may require a user identification and authentication process (e.g., authentication and verification) from a user. The user identification and authentication process may include, for example, an authentication using the user authentication module 250 or an authentication using a text message (e.g., short message service (SMS)) or a telephone call (e.g., a call center).

For example, the electronic device 201 may set whether to need a user authentication for using a payment application after the user identification and authentication process is executed. For example, as described above, after the user identification and authentication process is executed, the electronic device 201 may receive a payment application from the payment application server 203 and may install the received payment application.

According to an embodiment of the present disclosure, when a payment is made based on the second payment application 234, there may not be required a separate user authentication. Accordingly, there may be a separate limitation on payment limit, payment frequency, time when a payment is possible, and the like in a payment using the second payment application 234. In contrast, for example, as described above, a variety of limitations may not be applied to a payment using the first payment application 233 requiring a user authentication. For example, settings about use restrictions of the first payment application 233 and the second application 234 may be stored in the payment application server 203.

For example, an amount of money available to pay by the second payment application 234 may be configured to be smaller than an amount of money available to pay by the first payment application 233. The amount of money that is available to pay may mean a total amount of money for payment when a payment is made several times or may mean an amount of money that is available to pay once.

Moreover, for example, the number of times that a payment is made by the second payment application 234 may be configured to be smaller than the number of times that a payment is made by the first payment application 233. The number of times that a payment is made may mean, for example, the total number of times that a payment is made by the second payment application 234 or the number of times that a payment is made daily.

Moreover, for example, time when a payment is possible by the second payment application 234 may be configured to be limited for a designated time from a point in time when the second payment application 234 is configured to be in a condition in which a payment is possible.

Moreover, for example, in the case where the second payment application 234 is configured to comply with an europay Mastercard and Visa (EMV) tokenization standard, there is required an encryption Key for generating a cryptogram when a payment is made. In this case, the second payment application 234 may make a payment based on a limited used key to which a payment is limited with a fixed amount of money, fixed time, or fixed frequency. For example, the CRS 231 of the SE 230 may count payment frequency, payment time, or the like of the second payment application 234, allowing a payment to be made within a restricted range area by the limited used key. For example, the payment limit policy by the limited used key may be determined according to the policy of the payment application server 203 or the setting by the user of the electronic device 201.

Meanwhile, as described above, a payment limit may be, but not limited to, an example. For example, the payment limit range (e.g., an amount of money available to pay, the number of times that a payment is made, time when a payment is possible, or the like) by the second payment application 234 may be differently set according to the policy of a finance company, the policy of a member store including the external payment device 202, the feature of the second payment application 234, the policy of the payment application server 203, or the setting by the user.

For example, the electronic device 201 may provide a user with a user interface associated with the setting of a payment limit range, and the user may set the payment limit range through the user interface (e.g., a touch interface, or the like). According to another embodiment of the present disclosure, at least a part of the payment limit range may be set not to be changed in spite of a setting manipulation by a user. For example, the set payment limit range that is based on the policy of a finance company, the policy of a member store including the external payment device 202, the feature of the second payment application 234, the policy of the payment application server 203, or the like may be set not to be changed in spite of a setting manipulation by a user. That is, in the setting authority of the payment limit range, the setting by a user may be configured to be subordinated.

Moreover, for example, when receiving the second payment application 234 from the payment application server 203, the electronic device 201 may notify a user that a user identification and authentication (e.g., an authentication using the user authentication module 250 or an authentication using a text message or a telephone) is required. For example, if the user identification and authentication is successful, a user of the electronic device 201 may set the payment limit range about the second payment application 234.

Moreover, for example, the electronic device 201 (e.g., the processor 220) may change the payment limit range of the second payment application 234 based on whether to perform the user authentication. For example, the user authentication for changing the payment limit range may be set based on an external input (e.g., a user input, or an input received from the payment application server 203) in the second payment application 234. For example, if the user authentication is successful, a user may increase the payment limit range about the second payment application 234 using the electronic device 201. For example, the user may increase an available amount of money for payment, the available number of times that payments can be made, or the available time when payments can be made, of the second payment application 234 using the electronic device 201.

According to various embodiments of the present disclosure, the first payment application 233 (or the first payment information thereof) and the second payment application 234 (or the second payment information thereof) may be configured to be associated with the same financial account. For example, the processor 220 of the electronic device 201 may install two types of payment applications associated with a single financial account in the SE 230.

For example, the electronic device 201 may request the installation of payment applications, which are associated with the same financial account, in the payment application server 203 (e.g., a TSM, a TSP, or the like). The payment application server 203 may send, for example, the requested payment applications to the electronic device 201 in response to the installation request.

According to an embodiment of the present disclosure, the first payment application 233 and the second payment application 234 may be configured to be associated with the same credit card account. In the same credit card account, a payment by the first payment application 233 requiring a user authentication may not be limited to, for example, payment amount limit, payment time, or payment frequency. A payment by the second payment application 234, requiring a user authentication, that is associated with the same credit card account may be limited to, for example, payment amount limit, payment time, or payment frequency.

According to an embodiment of the present disclosure, as described above, payment applications that have the same credit card account may be exclusively registered in the AID list of the PPSE 232 by the CRS 231 of the SE 230. For example, the payment management module 221 may configure only one of the first payment application 233 and the second payment application 234, which have the same credit card account, to be in a condition in which a payment is possible, based on the power state of the battery 211.

For example, in the case where the remaining power of the battery 211 is included in a range of 1 to 10% of a rated power, the payment management module 221 may configure the second payment application 234 among the first and second payment applications 233, which are associated with the same credit card account, to be in a condition in which a payment is possible. As such, for example, an additional operation such as a user authentication (e.g., a fingerprint authentication) may not be included in a payment process using the second payment application 234.

Moreover, according to an embodiment of the present disclosure, when a payment is made, the mobile payment service server 204 may send a change message to the payment application server 203 (e.g., a TSM, a TSP, a payment approval server, or the like), and thus whether to need user authentications of payment applications which are associated with the same credit card account may be changed.

For example, the mobile payment service server 204 may receive a message (e.g., a low power mode message or a power-off message) indicating the state of low power or power-off from the electronic device 201. For example, the mobile payment service server 204 may receive the message (e.g., a low power mode message or a power-off message) indicating the state of low power or power-off from the electronic device 201 at a designated time (e.g., when the remaining power of the battery 211 is less than or equal to a designated value or when the electronic device 201 is powered off) and may recognize the battery state of the electronic device 201. Additionally or alternatively, for example, the mobile payment service server 204 may periodically exchange a message about the battery state with the electronic device 201, and thus the mobile payment service server 204 may recognize the battery state of the electronic device 201.

For example, in the case where the mobile payment service server 204 recognizes that the electronic device 201 is in the state of low power or power-off, the mobile payment service server 204 may send a message (e.g., a payment limit message) for limiting payment amount limit, payment time, or payment frequency to the payment application server 203. The external payment device 202 may receive, for example, the payment limit message through the payment application server 203. As such, for example, the electronic device 201 may make a payment, in which payment amount limit, payment time, or payment frequency is limited, with the external payment device 202 based on one of payment applications that are associated with the same credit card account.

According to various embodiments of the present disclosure, a payment application (or payment information) stored in a memory (e.g., SE 130, eSE, eUICC, micro SD card, or the like) and the near-field wireless communication module 240 may correspond to each other and may establish a NFC payment path. According to an embodiment of the present disclosure, the NFC payment path may be variously set in relations between different types of memories. For example, the near-field wireless communication module 240 may establish separate NFC payment paths with an eSE storing the first payment application 233 and a micro SD card storing the second application 234. According to an embodiment of the present disclosure, information about the NFC payment path may be stored in the NFC controller 241 or the payment management module 221.

According to various embodiments of the present disclosure, the payment management module 221 may be implemented to be embedded as firmware in the NFC controller 241, and the NFC controller 241 may be directly connected with the power management module 212, exchanging a message with the power management module 212.

For example, the NFC controller 241 in which the payment management module 221 is embedded may obtain power information from the processor 220 (or the power management module 212 thereof) based on power supplied through the RF module 242 from the external payment device 202. For example, in the case where the power of the battery 211 is less than or equal to a designated power value based on the power information (or in the case where an electronic device is powered off), the NFC controller 241 may control the CRS 231 of the SE 230 to register the AID (i.e., AID 1) of the second payment application 234 in the AID list of the PPSE 232. In the case where the electronic device 201 is in the situation of low power or power-off based on the supplied power, the NFC controller 241 may designate, for example, the second payment application 234 as a default payment application. Accordingly, according to an embodiment of the present disclosure, the changing of a payment application that is based on the power situation of the battery 211 may be performed without the intervention of the processor 220.

As described above, according to various embodiments of the present disclosure, the electronic device 201 may include a power module (e.g., the battery 211) configured to power the electronic device 201, a memory (e.g., the SE 230) configured to store first payment information using a user authentication and second payment information not using the user authentication, a near-field wireless communication module configured to send the first payment information or the second payment information stored in the memory to an external payment device 202, and a processor 220 configured to obtain power information of the power module, to set the memory such that the first payment information is sent to the external payment device 202 if a value corresponding to the power information is greater than or equal to a designated power value, and to set the memory such that the second payment information is sent to the external payment device 202 if the value corresponding to the power information is less than the designated power value.

According to an embodiment of the present disclosure, the processor 220 may correspond to an AP that is separately implemented with the near-field wireless communication module. The memory may include at least one of an eSE, a UICC, an eUICC, a micro SD card, or a SIM card.

Moreover, according to an embodiment of the present disclosure, the user authentication may include at least one of a fingerprint authentication, a PIN authentication, or a biometric authentication.

Moreover, according to an embodiment of the present disclosure, the electronic device 201 may further include an auxiliary power module 213 configured to preparatorily power the electronic device 201. At this time, the processor may set the memory based on power that the auxiliary power module supplies such that the first payment information or the second payment information is sent to the external payment device.

Moreover, according to an embodiment of the present disclosure, the first payment information and the second payment information may be configured to be associated with the same financial account.

Moreover, according to an embodiment of the present disclosure, if a value corresponding to the power information is less than the power value, the processor 220 may set the memory such that the second payment information is designated as default payment information. If the value corresponding to the power information is greater than or equal to the power value, the processor 220 may set the memory such that the first payment information is designated as default payment information.

According to various embodiments of the present disclosure, the electronic device 201 may include the battery 211 configured to power the electronic device 201, the SE 230 configured to store the first payment application 233 requiring a user authentication and the second payment application 234 not requiring the user authentication, the processor 220 configuring the second payment application 234 to be in a condition in which a payment is possible if remaining power of the battery 211 is less than or equal to a value; and the near-field wireless communication module 240 configured to send payment information, which is based on the second payment application 234, to the external payment device 202.

According to an embodiment of the present disclosure, the processor may configure the first payment application stored in the SE to be in a condition in which a payment is possible if remaining power of the battery is greater than a value.

Moreover, according to an embodiment of the present disclosure, the SE comprises a PPSE 232. At this time, the processor may configure, for example, the second payment application to be in a condition in which a payment is possible by registering the AID of the second payment application in the PPSE 232.

Moreover, according to an embodiment of the present disclosure, the near-field wireless communication module may establish a security channel with the external payment device based on the AID of the second payment application registered in the PPSE 232 and may send the payment data through the established security channel.

Moreover, the payment data may include the payment data comprises at least one of a token, at least some of a PAN, or a cryptogram.

Moreover, according to an embodiment of the present disclosure, an amount of money available to pay by the second payment application may be configured to be smaller than an amount of money available to pay by the first payment application, and the number of times that a payment may be made by the second payment application is configured to be smaller than the number of times that a payment is made by the first payment application. For example, time when a payment is possible by the second payment application may be configured to be limited for a designated time from a point in time when the second payment application is configured to be in the condition in which a payment is possible.

Moreover, according to an embodiment of the present disclosure, if remaining power of the battery is less than a value, the processor may configure the second payment application to be in a condition in which a payment is possible after performing the user authentication.

The electronic device 201 according to various embodiments of the present disclosure may include a memory configured to store first payment information (by the first payment application 233) using authentication information and second payment information (by the second payment application 234) not using the authentication information, the near-field wireless communication module 240 configured to send the first payment information or the second payment information to an external payment device, and the payment management module 221 placed outside the near-field wireless communication module 240. The payment management module 221 may be configured to verify power information of the power module (e.g., the battery 211) functionally connected with the electronic device 201, to send the first payment information to the external payment device through the near-field wireless communication module if the power information belongs to a first range, and to send the second payment information to the external payment device through the near-field wireless communication module if the power information belongs to a second range.

According to an embodiment of the present disclosure, the first payment information and/or the second payment information may information used (or required) to make a payment with the external payment device 202. For example, the first payment information and/or the second payment information may information of a finance card (e.g., a credit card, a check card, a debit card, or the like) or token information. For example, the electronic device 201 may send the first payment information and/or the second payment information to the external payment device 202. The external payment device 202 may send the first payment information and/or the second payment information to a corresponding card company and/or a corresponding server of a finance institution (e.g., the payment application server 203).

According to an embodiment of the present disclosure, the payment management module 221 may be implemented with an AP (e.g., an example of the processor 220) of the electronic device 201. For example, the payment management module 221 may exchange the first payment information or the second payment information with the external payment device 202 through the near-field wireless communication module 240. The payment management module 221 may be composed of an at least a part of the AP or may be composed of a module functionally connected with the AP.

According to an embodiment of the present disclosure, the memory (e.g., the SE 230) may include an eSE. For example, in the case where the electronic device 201 or the external payment device 202 accesses (e.g., a connection or a link) the memory in a manner except a designated manner, the memory may limit the access. For example, the payment management module 221 may access the memory through a designated module (e.g., the payment management module 221) and may control the CRS 231 included (e.g., stored or installed) in the memory.

According to an embodiment of the present disclosure, the first designated range may correspond to or may be included in a range in which a value corresponding to the power information is greater than or equal to a threshold value. For example, the threshold value may include a minimum power value for making a payment based on the first payment information. For example, the threshold value may be set to a designated power value (e.g., 300 mAh) of the power module or may be set to a ratio (e.g., 10%, or 20%) of the remaining power to a rated power of the power module. In the case where a value corresponding to the power information is greater than or equal to the threshold value, the payment management module 221 may determine, for example, the power information as belonging to the first designated range. Moreover, the threshold value may be set based on a user input sent to the electronic device 201, and the electronic device 201 may provide various user interfaces for receiving the user input.

According to an embodiment of the present disclosure, the second designated range may be included in a range in which a value corresponding to the power information is less than the threshold value. For example, the second designated range may correspond to the case where the power information is actually ‘0’. The state in which the power information is actually ‘0’ may include, for example, the state in which a value corresponding to the power information is less than a designated power value (e.g., 300 mAh) or a ratio corresponding to the power information is smaller than a ratio (e.g., 10%, or 20%) of the remaining power to a rated power (or regular capacity). According to another embodiment of the present disclosure, the second designated range may correspond to, for example, a range except the first designated range. Moreover, in the case where the power module is suddenly discharged or in the case where the power module is removed from the electronic device 201, the second designated range may correspond to the case where an electronic device is powered off.

According to an embodiment of the present disclosure, the electronic device 201 may further include an auxiliary power module 213. The payment management module may be configured to send the first payment information or the second payment information to the external payment device 202 based on the auxiliary power module 213.

For example, in the case where the power information of the power module belongs to the second designated range (e.g., in the case where the power module is suddenly discharged, in the case where the power module is removed from the electronic device 201, or the like), the payment management module 221 may be set such that the auxiliary power module 213 is utilized. Moreover, according to another embodiment of the present disclosure, the electronic device 201 may make a payment based on the power module and the auxiliary power module 214. For example, the electronic device 201 may send the first payment information or the second payment information to the external payment device 202 based on both the remaining power of a power module and the power of the auxiliary power module 214.

According to an embodiment of the present disclosure, the payment management module 221 may be configured to generate the first payment information and the second payment information based on a piece of payment information. For example, the payment management module 221 may generate payment information of which data (e.g., a card number) for payment is identical but of which attributions are different from each other. For example, the payment management module 221 may generate the first payment information and the second payment information based on a piece of card information. The first payment information may be configured to perform a user authentication, and the second payment information may be configured not to perform a user authentication. The payment management module 221 may generate, for example, the payment information based on whether to set the user authentication. Moreover, for example, the payment management module 221 may set the first payment information and/or the second payment information in a memory based on the power of the power module.

According to an embodiment of the present disclosure, the payment management module 221 may be configured to designate payment information, which is sent to the external payment device, from among the first payment information and the second payment information as default payment mean information. For example, the payment management module 221 may set the memory such that one of the first payment information or the second payment information is designated as default payment information. Moreover, for example, in the case where the payment information included in the memory is only one, the payment management module 221 may set a piece of payment information (e.g., the first payment information or the second payment information) included in the memory as the default payment information.

Referring to FIG. 2, various elements included in the electronic device 201 may be included in one device. However, a containment relation or an arrangement configuration of the various elements may be limited thereto. For example, at least a part of elements of the electronic device 201 may be implemented to be distributed in the electronic device 201 and an external payment device (e.g., the external payment device 202, the payment application server 203, or a mobile payment service server 204) based on a role, function, or performance of the electronic device 201.

Moreover, according to various embodiments of the present disclosure, at least a part of the payment management module 221 or the power management module 310 may be implemented by software, firmware, hardware, or a combination of two or more thereof. At least a part of the payment management module 221 or the power management module 310 may be implemented (e.g., executed), for example, by a processor (e.g., a processor 220). At least a part of the payment management module 221 or the power management module 310 may include, for example, modules, programs, routines, sets of instructions, or processes, or the like for executing one or more functions.

FIGS. 3A to 3C are flowcharts for describing a payment method according to various embodiments of the present disclosure.

Referring to FIG. 3A, the payment method according to an embodiment of the present disclosure may include operations 311, 313, 315, and 317. Each operation illustrated in FIG. 3A may be described with reference to a reference number of FIG. 2.

In operation 311, the electronic device 201 (e.g., the processor 220, or the payment management module 221) may obtain, for example, the power information (e.g., remaining power) of a power module (e.g., the battery 211) functionally connected to the electronic device 201 based on the power management module 212. For example, the power management module 212 may determine whether the power module is discharged or charged. The power information of the power module may be provided to, for example, the processor 220 of the electronic device 201.

In operation 313, the electronic device 201 (e.g., the processor 220, or the payment management module 221) may determine, for example, whether a value corresponding to the power information of the power module is less than or equal to (or is less than) a designated power value (e.g., 300 mAh, a rated power of 10%, or the like). If the value corresponding to the power information of the power module is less than or equal to the designated power value, the procedure may proceed to operation 315. Otherwise, the procedure may proceed to operation 317.

In operation 315, in the case where the value corresponding to the power information of the power module is less than or equal to (or is less than) a designated power value (“Yes” in operation 313), the electronic device 201 (e.g., the processor 220 or the payment management module 221) may set, for example, a memory (e.g., the SE 230) such that the second payment information, which does not accompany a user authentication, stored in the memory is able to be sent to the external payment device 202.

According to an embodiment of the present disclosure, the user authentication may include a fingerprint authentication, a PIN authentication, a biometric authentication, or the like. Moreover, for example, the memory may include an eSE, a UICC, an eUICC, a micro SD card, a SIM card, or the like.

Moreover, according to an embodiment of the present disclosure, the second payment information may correspond to, for example, the payment information or the payment data of the second payment application 234. For example, there may be a limitation on payment limit, payment frequency, time when a payment is possible, and the like in a payment using the second payment application 234.

In operation 317, in the case where the value corresponding to power information of the power module is greater than (or is greater than or equal to) the designated power value (“No” in operation 313), the electronic device 201 (e.g., the processor 220 or the payment management module 221) may set, for example, a memory such that the first payment information, which accompanies a user authentication, stored in the memory is able to be sent to the external payment device 202. For example, the first payment information may correspond to the payment information or the payment data of the first payment application 233.

According to an embodiment of the present disclosure, the first payment information and the second payment information may be configured to be associated with the same financial account. Moreover, for example, the first payment information or the second payment information may be designated as default payment information.

Referring to FIG. 3A, it is described that the payment method according to various embodiments of the present disclosure is ended after operations 315 and 317. However, the payment method may return to operation 311 and the electronic device 201 may again obtain battery power. Moreover, according to an embodiment of the present disclosure, the payment process illustrated in FIG. 7 may be executed after operation 315. The payment process illustrated in FIG. 8 may be executed after operation 317.

Referring to FIG. 3B, the payment method according to an embodiment of the present disclosure may include operations 321, 323, 325, and 327. Each operation illustrated in FIG. 3B may be described with reference to a reference number of FIG. 2.

In operation 321, the electronic device 201 (e.g., the processor 220, or the payment management module 221) may verify, for example, the power information (e.g., remaining power) of a power module (e.g., the battery 211) functionally connected to the electronic device 201 based on the power management module 212. For example, the power management module 212 may determine whether the power module is discharged or charged. The power information may be provided to, for example, the processor 220 of the electronic device 201.

In operation 323, the electronic device 201 (e.g., the processor 220 or the payment management module 221) may determine, for example, whether the power information of the power module belongs to a first designated range or a second designated range.

According to an embodiment of the present disclosure, the first designated range may correspond to or may be included in a range in which a value corresponding to the power information is greater than or equal to (or is greater than) a threshold value. For example, the threshold value may include a minimum power value for making a payment based on the first payment information. For example, the threshold value may be set to a designated power value (e.g., 300 mAh) of the power module or may be set to a ratio (e.g., 10%, or 20%) of the remaining power to a rated power of the power module.

According to an embodiment of the present disclosure, the second designated range may be included in a range in which a value corresponding to the power information is less than (or is less than or equal to) the threshold value. For example, the second designated range may correspond to the case where a value corresponding to the power information is actually ‘0’. The state in which the power information is actually ‘0’ may include, for example, a state in which a value corresponding to the power information is less than a designated power value (e.g., 300 mAh) or a ratio corresponding to the power information is smaller than a ratio (e.g., 10%, or 20%) of the remaining power to the rated power. According to another embodiment of the present disclosure, the second designated range may correspond to, for example, a range except the first designated range. Moreover, in the case where the power module is suddenly discharged or in the case where the power module is removed from the electronic device 201, the second designated range may correspond to the case where an electronic device is powered off.

For example, if the power information of the power module belongs to the first designated range, the procedure may proceed to operation 327. On the other hand, if the power information of the power module belongs to the second designated range, the procedure may proceed to operation 325.

In operation 325, in the case where the power information of the power module belongs to the second designated range, the electronic device 201 (e.g., the processor 220 or the payment management module 221) may send, for example, the second payment information, which does not accompany a user authentication, stored in a memory (e.g., the SE 230) to the external payment device 202 through the near-field wireless communication module 240.

According to an embodiment of the present disclosure, the authentication information may include fingerprint authentication information, PIN authentication information, biometric authentication information, or the like. Moreover, for example, the memory may include an eSE, a UICC, an eUICC, a micro SD card, a SIM card, or the like.

Moreover, according to an embodiment of the present disclosure, the second payment information may correspond to, for example, the payment information or the payment data of the second payment application 234. For example, there may be a limitation on payment limit, payment frequency, time when a payment is possible, and the like in a payment using the second payment application 234.

In operation 327, in the case where the power information of the power module belongs to the first designated range, the electronic device 201 (e.g., the processor 220 or the payment management module 221) may send, for example, the first payment information, which accompanies a user authentication, stored in a memory (e.g., the SE 230) to the external payment device 202 through the near-field wireless communication module 240. For example, the first payment information may correspond to the payment information or the payment data of the first payment application 233.

According to an embodiment of the present disclosure, the electronic device 201 (e.g., the processor 220, or the payment management module 221) may generate the first payment information and the second payment information based on a piece of payment information (e.g., card information, or the like). As such, for example, the first payment information and the second payment information may be configured to be associated with the same financial account.

Moreover, for example, the electronic device 201 (e.g., the processor 220, or the payment management module 221) may designate payment information, which is sent to the external payment device, of the first payment information or the second payment information as default payment information.

Referring to FIG. 3B, it is described that the payment method according to various embodiments of the present disclosure is ended after operation 325 and operation 327. However, the payment method may return to in operation 321, the electronic device 201 may again verify battery power. According to an embodiment of the present disclosure, the payment process illustrated in FIG. 7 may be executed after operation 325. The payment process illustrated in FIG. 8 may be executed after operation 327.

Referring to FIG. 3C, the payment method according to an embodiment of the present disclosure may include operations 331, 333, 335, and 337. Each operation illustrated in FIG. 3B may be described with reference to a reference number of FIG. 2.

In operation 331, the electronic device 201 (e.g., the processor 220 or the payment management module 221) may monitor (or verify), for example, the remaining power of the embedded the battery 211 based on the power management module 212. For example, the power management module 212 may determine whether the battery 211 is discharged or charged. The power information of the battery 211 may be provided to, for example, the processor 220 of the electronic device 201.

In operation 333, the electronic device 201 (e.g., the processor 220 or the payment management module 221) may determine, for example, whether the remaining power of the battery 211 is less than or equal to (or is less than) a designated value. If the remaining power of the battery 211 is less than or equal to the designated value, the procedure may proceed to operation 335. Otherwise, the procedure may proceed to operation 337.

In operation 335, in the case where the remaining power of the battery 211 is less than or equal to (or is less than) a designated value (“Yes” in operation 333), the electronic device 201 (e.g., the processor 220 or the payment management module 221) may configure, for example, the second payment information, which does not accompany a user authentication, stored in the SE 230 to be in a condition in which a payment is possible.

For example, the AID of the second payment application 234 may be exclusively registered in the AID list of the PPSE 232 of the SE 230, and thus the second payment application 234 may be designated as a default payment application. For example, the processor 220 may control the CRS 231 of the SE 230 to register the AID (i.e., AID 1) of the second payment application 234 in the AID list of the PPSE 232 and to discard the AID of another payment application from the AID list. For example, the SE 230 (or the PPSE 232 thereof) may be set such that the second payment information (e.g., payment data) of the second payment application 234 is sent to the external payment device 202.

Moreover, in operation 335, according to an embodiment of the present disclosure, after performing a separate user authentication based on the user authentication module 250, the electronic device 201 may configure the second payment application 234 to be in a condition in which a payment is possible.

Moreover, according to an embodiment of the present disclosure, in the operation 335, the electronic device 201 (e.g., the processor 220 or the payment management module 221) may notify a user that the battery 211 is in a low power state and that the second payment application 234 is in a condition in which a payment is possible, through a display, or the like. Moreover, for example, the electronic device 201 may notify a user of the low power state (i.e., the fact that the remaining power of the battery 211 is less than or equal to (or is less than) a designated value) through a pop-up window, or the like of a display and may ask a user whether the second payment application 234 is configured to be in a condition in which a payment is possible.

Accordingly, according to an embodiment of the present disclosure, there may be a limitation on payment limit, payment frequency, time when a payment is possible, and the like in a payment using the second payment application 234. In operation 335, the electronic device 201 may previously generate, for example, a limited used key for a limited payment of the second payment application 234.

In operation 337, in the case where the remaining power of the battery 211 is greater than (or is greater than or equal to) a designated value (“No” in operation 333), the electronic device 201 (or the payment management module 221 thereof) may configure, for example, the first payment application, which requires a user authentication, stored in the SE 230 to be in a condition in which a payment is possible.

For example, the AID of the first payment application 233 may be exclusively registered in the AID list of the PPSE 232 of the SE 230, and thus the first payment application 233 may be designated as a default payment application. For example, the processor 220 may control the CRS 231 to register the AID (i.e., AID 0) of the first payment application 233 in the AID list of the PPSE 232 and may allow the CRS 231 of the SE 230 to discard the AID of another payment application from the AID list. For example, the SE 230 (or the PPSE 232 thereof) may be set such that the first payment information (e.g., payment data) of the first payment application 233 is sent to the external payment device 202.

Moreover, in operation 337, for example, after performing a separate user authentication based on the user authentication module 250, the electronic device 201 (e.g., the processor 220 or the payment management module 221) may configure the first payment application 233 to be in a condition in which a payment is possible.

According to various embodiments of the present disclosure, the first payment application 233 requiring a user authentication may be registered in the AID list of the PPSE 232. Moreover, according to various embodiments of the present disclosure, the first payment application 233 requiring a user authentication and the second payment application 234 not requiring a user authentication may be configured to be exclusively registered in the AID list of the PPSE 232.

Referring to FIG. 3C, it is described that the payment method according to various embodiments of the present disclosure is ended after operation 335 and operation 337. However, the payment method may return to operation 331, and the electronic device 201 may monitor battery power. According to an embodiment of the present disclosure, the payment process illustrated in FIG. 7 may be executed after operation 335. The payment process illustrated in FIG. 8 may be executed after operation 337.

In the case where the remaining power of the battery 211 is less than or equal to (or is less than) a designated value, the electronic device 201 according to an embodiment of the present disclosure may configure a payment application, which does not requires a user authentication, to be in a condition in which a payment is possible. A user of the electronic device 201 may make a mobile payment using the electronic device 201, which is in a low power state or a power-off state, without a user authentication that is independent of the external payment device 202.

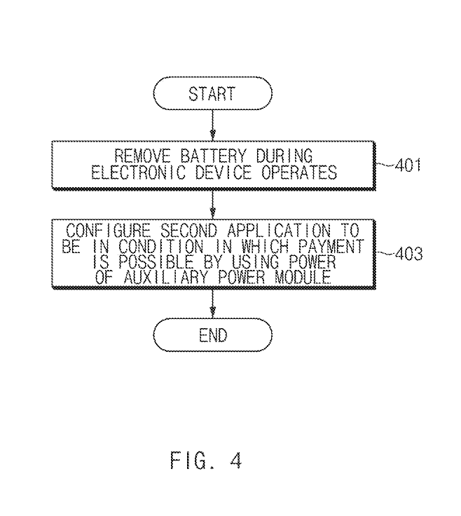

FIG. 4 illustrates a payment flowchart when a battery is removed (or removable), according to an embodiment of the present disclosure.

Referring to FIG. 4, the payment method is illustrated when the battery 211 is removed from the electronic device 201. With regard to FIGS. 3A to 3C, a duplicated description is omitted.

In operation 401, the battery 211 may be (suddenly) removed from, for example, the electronic device 201. Because the battery 211 is removed from the electronic device 201, elements included in the electronic device 201 may not receive power from the battery 211.

In operation 401, it is described that the battery 211 is removed from the electronic device 201. However, the case where the electronic device 201 is powered off may include the case where the remaining power of the battery 211 described in FIG. 3B is included in the second designated range, for example, the case where the remaining power is actually ‘0’ due to a sudden discharge.

In operation 403, if a power supply by the battery 211 is interrupted, the electronic device 201 may temporarily use, for example, power that the auxiliary power module 213 (e.g., an auxiliary capacitor) supplies. The electronic device 201 (or the payment management module 221 thereof) may configure, for example, the second payment application 234 to be in a condition, in which a payment is possible, based on the power that the auxiliary power module 213 supplies. Operation 403 may include at least a part of operation 315 of FIG. 3A, operation 325 of FIG. 3B, and operation 335 of FIG. 3C.

In the case where the battery 211 is suddenly removed from the electronic device 201, the electronic device 201 according to an embodiment of the present disclosure may configure a payment application, which does not requires a user authentication, to be in a condition, in which a payment is possible, based on the auxiliary power module 213. A user of the electronic device 201 may make a mobile payment with the external payment device 202 using the electronic device 201 in which a power supply is interrupted.

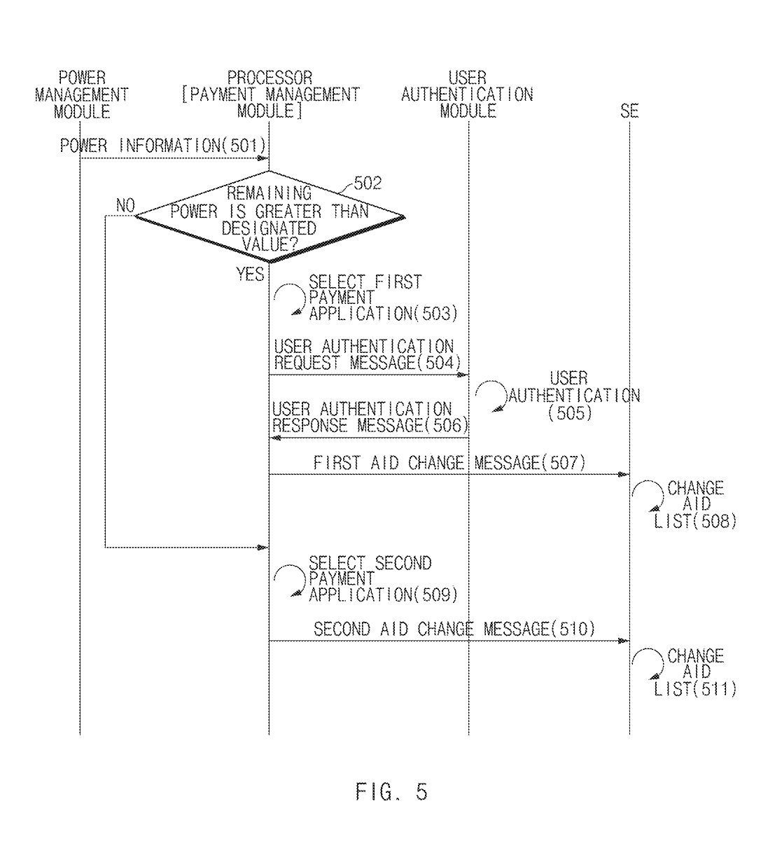

FIG. 5 illustrates a payment method of an electronic device according to an embodiment of the present disclosure.

Referring to FIG. 5, the payment method of the electronic device 201 according to an embodiment of the present disclosure may include operations 501 to 511. With regard to FIGS. 3C and 4, a duplicated description is omitted.

In operation 501, For example, the power management module 212 may monitor the remaining capacity of the battery 211, providing power information of the battery 211 to the processor 220 (or the payment management module 221 of the processor 220). For example, the power management module 212 may provide the power information in response to the request of the processor 220 or may provide the power information every fixed period. Moreover, for example, in the case where the remaining capacity of the battery 211 corresponds to at least one threshold value, the power management module 212 may provide the power information.

In operation 502, the payment management module 221 may determine, for example, whether the remaining power of the battery 211 is greater than a designated value (or is greater than or equal to a designated value), based on power information received from the power management module 212. For example, if the remaining power of the battery 211 is greater than the designated value, the procedure may proceed to operation 503. Otherwise, the procedure may proceed to operation 509.

For example, in the case where the remaining power of the battery 211 is greater than (or is greater than or equal to) the designated value (“Yes” in operation 502), in operation 503, the payment management module 221 may select the first payment application 233 requiring a user authentication.

For example, in operation 504, the payment management module 221 may select the first payment application 233 requiring a user authentication, and thus the payment management module 221 may send a user authentication request message to the user authentication module 250.

In operation 505, if receiving the user authentication request message, the user authentication module 250 may obtain, for example, authentication information (e.g., fingerprint information) from a user. For example, the user authentication module 250 may check (or compare) the authentication information with the previously registered authentication information, determining whether a user inputting the authentication information is the previously registered user.

In operation 506, if a user authentication is successful in operation 505, the user authentication module 250 may send, for example, a user authentication response message to the payment management module 221. Moreover, in the case where the user authentication fails, the user authentication module 250 may send, for example, a user non-authentication response message (not shown) to the payment management module 221. In the case where the user authentication fails, the electronic device 201 may notify a user of the failure of a user authentication through a display, a motor, or a speaker that is functionally connected to the electronic device 201.

For example, in operation 507, if receiving the user authentication response message in operation 506, the payment management module 221 may send, to the SE 230, a first AID change message for registering the AID (i.e., AID 0) of the first payment application 233 selected in operation 503 in the AID list. For example, in operation 507, if receiving the user non-authentication response message, the payment management module 221 may not send the first AID change message to the SE 230 even though the first payment application 233 is selected in operation 503.

According to an embodiment of the present disclosure, in operation 507, if receiving the user non-authentication response message at least a designated count, the payment management module 221 may configure the first payment application 233 to be in an unavailable state by deactivating the corresponding first payment application 233 in the SE 230.

In operation 508, for example, the SE 230 may change the AID list of the PPSE 232 through the CRS 231 based on the first AID change message received from the payment management module 221. For example, the CRS 231 may register the AID (i.e., AID 0) of the first payment application 233 in the AID list of the PPSE 232. As such, for example, the first application 233 may be configured to be in a condition in which a payment is possible.

Meanwhile, for example, in the case where the remaining power of the battery 211 is less than or equal to the designated value (“No” in operation 502) in operation 502, in operation 509, the payment management module 221 may select the second payment application 233 not requiring a user authentication.

In operation 510, the payment management module 221 may send, to the SE 230, a second AID change message for registering the AID (i.e., AID 1) of the second payment application 234 selected in operation 509 in the AID list.

In operation 511, for example, the SE 230 may change the AID list of the PPSE 232 through the CRS 231 based on the second AID change message received from the payment management module 221. For example, the CRS 231 may register the AID (i.e., AID 1) of the second payment application 234 in the AID list of the PPSE 232. As such, for example, the second application 234 may be configured to be in a condition in which a payment is possible.

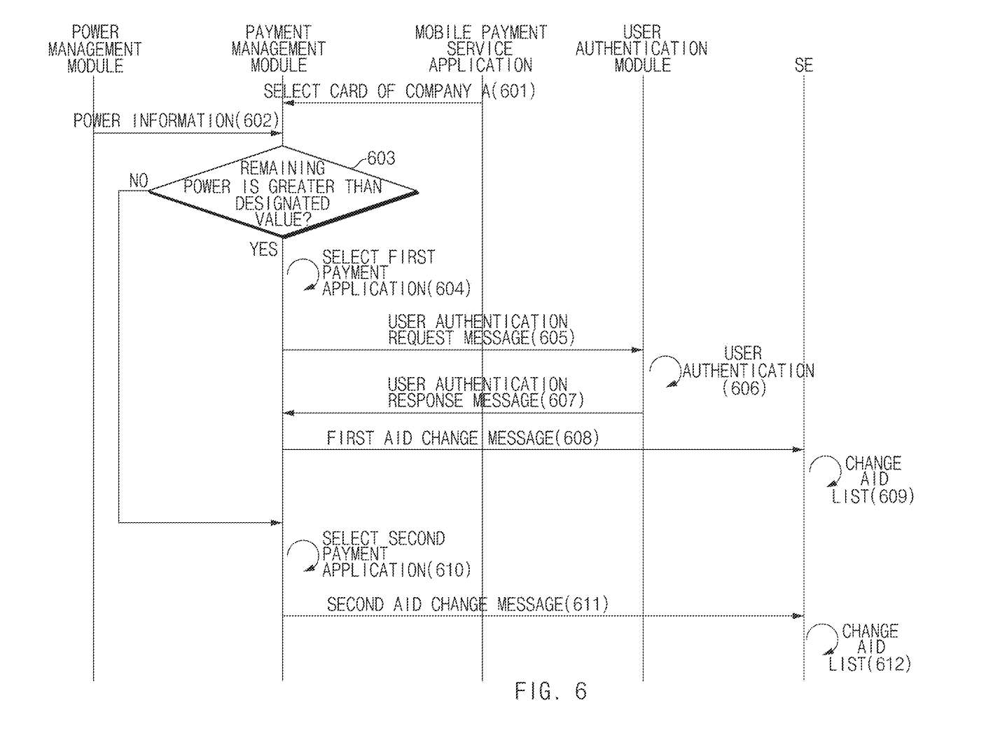

FIG. 6 illustrates a payment method of an electronic device according to various embodiments of the present disclosure.

According to various embodiments of the present disclosure, a plurality of payment applications may be stored in the SE 230 of the electronic device 201. For example, four payment applications may be stored in the SE 230. For example, the first payment application 233 and second payment application 234 of the four payment applications may be associated with a (or the same) credit card account of card company A (hereinafter, company A), a third payment application may be associated with a financial account of bank B, and a fourth payment application may be associated with a credit card account of card company C.

It is described that the first to fourth payment application are associated with a credit card account. However, an embodiment of the inventive concept may not be limited thereto. For example, the first to fourth payment application may be associated with accounts of various types of cards for making a payment, for example, a check card account, a debit card account, or a prepaid card account. As described above, an embodiment of a payment method through the SE 230 storing the four payment applications may be described with reference to FIG. 6. With regard to FIGS. 3C, 4 and 5, a duplicated description is omitted.

Referring to FIG. 6, in operation 601, the processor 220 may perform, for example, a mobile payment service application (e.g., Samsung pay application). For example, a user may select a credit card of company A through various user interfaces of the mobile payment service application. Information associated with the selection of the credit card of company A may be sent to the payment management module 221.

In operation 602, For example, the power management module 212 may monitor the remaining power of the battery 211, providing the power information of the battery 211 to the payment management module 221.

In operation 603, the payment management module 221 may determine, for example, whether the remaining power of the battery 211 is greater than a designated value (or is greater than or equal to a designated value), based on power information received from the power management module 212. For example, if the remaining power of the battery 211 is greater than the designated value, the procedure may proceed to operation 604. Otherwise, the procedure may proceed to operation 610.

For example, in the case where the remaining power of the battery 211 is greater than (or is greater than or equal to) the designated value (“Yes” in operation 603), in operation 604, the payment management module 221 may select the first payment application 233 requiring a user authentication, from among payment applications associated with a credit card of company A selected in operation 601.

For example, in operation 605, the payment management module 221 may select the first payment application 233 requiring a user authentication, sending a user authentication request message to the user authentication module 250.

In operation 606, if receiving the user authentication request message, the user authentication module 250 may obtain, for example, authentication information (e.g., fingerprint information) from a user. For example, the user authentication module 250 may check (or compare) the authentication information with the previously registered authentication information, determining whether a user inputting the authentication information is the previously registered user.

In operation 607, if a user authentication is successful in operation 606, the user authentication module 250 may send, for example, a user authentication response message to the payment management module 221. Moreover, in the case where the user authentication fails, the user authentication module 250 may send, for example, a user non-authentication response message (not shown) to the payment management module 221. In the case where the user authentication fails, the electronic device 201 may notify a user of the failure of a user authentication through a display, a motor, or a speaker that is functionally connected to the electronic device 201.

For example, if receiving the user authentication response message in operation 607, in operation 608, the payment management module 221 may send, to the SE 230, a first AID change message for registering the AID (i.e., AID 0) of the first payment application 233 selected in operation 604 in the AID list. For example, in operation 608, if receiving the user non-authentication response message, the payment management module 221 may not send the first AID change message to the SE 230 even though the first payment application 233 of the credit card of company A is selected in operation 604.

In operation 609, for example, the SE 230 may change the AID list of the PPSE 232 through the CRS 231 based on the first AID change message received from the payment management module 221. For example, the CRS 231 may register the AID (i.e., AID 0) of the first payment application 233 in the AID list of the PPSE 232. As such, for example, the first application 233 of the credit card of company A may be configured to be in a condition in which a payment is possible.

Meanwhile, for example, in the case where the remaining power of the battery 211 is less than or equal to the designated value (“No” in operation 603) in operation 603, in operation 610, the payment management module 221 may select the second payment application 234, which does not require a user authentication, from among payment applications associated with the credit card of company A selected in operation 601.

In operation 611, the payment management module 221 may send, to the SE 230, a second AID change message for registering the AID (i.e., AID 1) of the second payment application 234 selected in operation 610 in the AID list.

In operation 612, for example, the SE 230 may change the AID list of the PPSE 232 through the CRS 231 based on the second AID change message received from the payment management module 221. For example, the CRS 231 may register the AID (i.e., AID 1) of the second payment application 234 in the AID list of the PPSE 232. As such, for example, the second application 234 of the credit card of company A may be configured to be in a condition in which a payment is possible.

FIG. 7 illustrates a payment process when a battery of an electronic device according to an embodiment of the present disclosure has remaining power greater than a designated value.

Referring to FIG. 7, when the battery 211 of the electronic device 201 has the remaining power greater than a designated value (or greater than or equal to a designated value), the payment process between the electronic device 201 and the external payment device 202 is illustrated. Operations 701 to 703, 705, 707 to 711, and 713 may be performed, for example, after operations 311, 313, and 317 illustrated in FIG. 3A are performed, after operations 321, 323, and 327 illustrated in FIG. 3B are performed, after operations 331, 333, and 337 illustrated in FIG. 3C are performed, after operations 501 to 508 illustrated in FIG. 5 are performed, or after operations 601 to 609 illustrated in FIG. 6 are performed.

In operation 701, the electronic device 201 may receive, for example, a payment initiation message, which is based on a designated protocol, from the external payment device 202 through the near-field wireless communication module 240. The payment initiation message may be sent to, for example, the SE 230.

In operation 702, the electronic device 201 may perform, for example, a user authentication by using the user authentication module 250. According to various embodiments of the present disclosure, the user authentication in operation 702 may be performed before the payment initiation message is received in operation 701.

Moreover, according to various embodiments of the present disclosure, the user authentication in operation 702 may be omitted.

In operation 703, the PPSE 232 of the SE 230 of the electronic device 201 may send a payment means relation message including an AID list and/or priority information to the external payment device 202 through the near-field wireless communication module 240.

For example, in the case where the AID (i.e., AID 0) of the first payment application 233 is registered in the AID list, the PPSE 232 may send, to the external payment device 202, “1” as the AID 0 and the priority information. Moreover, in the case where the AIDs of three payment applications are registered in the AID list, the PPSE 232 may send, for example, the AIDs of three payment applications included in the AID list and the priority information to the external payment device 202.

In operation 705, a user may select, for example, a payment application to be used to make an actual payment by using the external payment device 202. The user may select, for example, a payment application to be used to make a payment based on the AID list and priority information received from the electronic device 201.

For example, in the case where only the AID of the first payment application 233 is in the AID list, the user may select the AID of the corresponding first payment application 233. In the case where the AIDs of a plurality of payment applications is registered in the AID list, the user may select the AID of at least one payment application of the AIDs of a plurality of payment applications.

In operation 707, the external payment device 202 may send, for example, the payment means selection message including information (e.g., AID 0) associated with the selected payment application (e.g., the first payment application 233) to the electronic device 201. The electronic device 201 may send, for example, the payment means selection message to the SE 230 included in the electronic device 201.

In operation 708, the electronic device 201 may perform, for example, a user authentication of the selected payment application (e.g., the first payment application 233). If the user authentication is successful, the electronic device 201 may proceed to operation 709. If the user authentication fails, the electronic device 201 may return (or send), for example, a failure message (e.g., an error) to a user or the external payment device 202.

According to various embodiments of the present disclosure, for example, the user authentication in operation 708 may be performed to be added to or replaced with the user authentication in operation 702. For example, the electronic device 201 may perform user authentications in operations 702 and 708. Alternatively, the electronic device 201 may perform a user authentication in operation 702 or 708. Alternatively, the electronic device 201 may omit user authentications in operations 702 and 708.

In operation 709, the electronic device 201 may establish, for example, a security channel (e.g., an encryption channel) with the external payment device 202. The security channel may access, for example, the selected payment application (e.g., the first payment application 233) and may correspond to a communication channel where payment data of the selected payment application is sent and received. For example, the security channel may be established based on the AID of the selected payment application. The operation 709 may include the process for sending and receiving at least one or more messages.

In operation 710, the electronic device 201 may perform, for example, a user authentication of the selected payment application (e.g., the first payment application 233). If the user authentication is successful, the electronic device 201 may proceed to operation 711. If the user authentication fails, the electronic device 201 may return (or send), for example, a failure message (e.g., an error) to a user and/or the external payment device 202.

According to various embodiments of the present disclosure, for example, the user authentication in operation 710 may be performed to be added to or replaced with the user authentications in operations 702 and 708. For example, the electronic device 201 may perform user authentications in operations 702, 708, and 710. Alternatively, for example, the electronic device 201 may perform a user authentication in at least one of operations 702, 708, or 710.

In operation 711, the electronic device 201 may generate and send, for example, payment data of a payment application (e.g., the first payment application 233) selected in operation 705 through the security channel established in operation 709. The payment data may include, for example, a variety of information such as a token, token validity period, at least a part of a PAN, a cryptogram being payment data generated every payment, or the like. According to an embodiment of the present disclosure, in the case where a user authentication fails in at least one of operation 501, 508, or 510, the various types of payment data may not be generated or sent.

For example, in operation 713, the external payment device 202 may communicate with a card company and/or the server of a finance institution (e.g., the payment application server 203) through an external network (e.g., a PoS system network) based on the payment data received in operation 711, making a payment.

FIG. 8 illustrates a payment method when a battery of an electronic device according to an embodiment of the present disclosure has remaining power less than or equal to (or is less than) a designated value.

Referring to FIG. 8, when the battery 211 of the electronic device 201 has the remaining power less than or equal to (or less than) a designated value, a payment process between the electronic device 201 and the external payment device 202 is illustrated. Operations 801, 803, 805, 807, 809, 811, and 813 may be performed, for example, after operations 311, 313, and 315 illustrated in FIG. 3A are performed, after operations 321, 323, and 325 illustrated in FIG. 3B are performed, after operations 331, 333, and 335 illustrated in FIG. 3C are performed, after operations 401 and 403 illustrated in FIG. 4 are performed, after operations 501, 502, and 509 to 511 illustrated in FIG. 5 are performed, or after operations 601 to 603, and 610 to 612 illustrated in FIG. 6 are performed.

According to an embodiment of the present disclosure, power used when the electronic device 201 sends a message or data may be supplied from the external payment device 202 through the near-field wireless communication module 240. In FIG. 8, an embodiment is exemplified as the battery 211 is a low power state (in the case where the battery 211 has the remaining power less than or equal to (or less than) a designated value). However, according to various embodiments of the present disclosure, even though the electronic device 201 is a power-off state (e.g., in the case where the remaining power is actually ‘0’%, in the case where the battery 211 is removed, or the like), operations corresponding to operations of FIG. 8 may be performed.

In operation 801, the electronic device 201 may receive a payment initiation message according to a designated protocol from the external payment device 202 through the near-field wireless communication module 240. For example, the payment initiation message may be sent to, for example, the SE 230.

In operation 803, the PPSE 232 of the SE 230 of the electronic device 201 may send a payment means relation message including an AID list and priority information of PPSE 232 to the external payment device 202 through the near-field wireless communication module 240. Because the AID (i.e., AID 1) of the second payment application 234 is exclusively registered in the AID list, the PPSE 232 may send, to the external payment device 202, “1” as the AID list including AID 1 and the priority information.

In operation 805, a user may select, for example, a payment application to be used to make an actual payment based on the external payment device 202. The user may select a payment application to be used to make a payment based on the AID list and priority information received from the electronic device 201. Because the AID 1 is exclusively registered in the AID list of the payment means relation message received from the electronic device 201, a user may select the second payment application 234 as a payment application to be used to make an actual payment.

In operation 807, the external payment device 202 may send, for example, the payment means selecting message including information (e.g., AID 1) associated with the selected payment application (e.g., the second payment application 234) to the SE 230 of the electronic device 201.

In operation 809, the electronic device 201 may establish, for example, a security channel (e.g., an encryption channel) with the external payment device 202. For example, the security channel may access the selected payment application (e.g., the second payment application 234) and may correspond to a communication channel where payment data of the selected payment application is sent and received. For example, the security channel may be established based on the AID of the second selected payment application 234. The operation 809 may include the process for sending and receiving at least one or more messages.

In operation 811, the SE 230 of the electronic device 201 may send payment data of the second payment application 234 selected in operation 805 through the security channel established in operation 809. The payment data may include, for example, a variety of information such as a token, token validity period, at least a part of a PAN, a cryptogram being payment data generated every payment, or the like.

In operation 813, the external payment device 202 may communicate with a card company and/or the server of a finance institution based on the payment data received in operation 811 through an external network, making a payment.

The operations (e.g., operations 311, 313, 315, and 317, operations 321, 323, 325, and 327, operations 331, 333, 335, and 337, operations 401 and 403, operations 501 to 511, operations 601 to 612, operations 701 to 703, 705, 707 to 711, and 713, or operations 801, 803, 805, 807, 809, 811, and 813) described with reference to the process and the method illustrated in FIGS. 3A to 3C, and FIGS. 4 to 8 executed by a successive method, a parallel method, a repeated method, or a heuristic method. For example, the operations may be executed in different sequences, a part of the operations may be omitted, or other operations may be added to said operations.

As described above, according to various embodiments of the present disclosure, a payment method of the electronic device 201 may include obtaining payment information of a power module (e.g., the battery 211) functionally connected to the electronic device 201, setting a memory such that first payment information using a user authentication is sent to the external payment device 202 in the case where a value corresponding to the power information is greater than or equal to a designated power value, and setting the memory such that second payment information not using a user authentication is sent to an external payment device 202 in the case where the value corresponding to the power information is less than a designated power value.

Moreover, according to an embodiment of the present disclosure, the memory may include at least one of an eSE, an UICC, an eUICC, a micro SD card, and a SIM card, and the user authentication may include at least one of a fingerprint authentication, a PIN authentication, or a biometric authentication. Moreover, the payment data may include, for example, at least one of a token, at least a part of a PAN, or a cryptogram.

Moreover, according to an embodiment of the present disclosure, the first payment information or the second payment information may be set in the memory such that the first payment information or the second payment information is sent to the external payment device 202 based on power supplied from the auxiliary power module 213.

Moreover, according to an embodiment of the present disclosure, the first payment information and the second payment information may be configured to be associated with the same financial account.

Moreover, according to an embodiment of the present disclosure, an amount of money available to pay by the second payment application is configured to be smaller than an amount of money available to pay by the first payment application, and the number of times that a payment is made by the second payment application is configured to be smaller than the number of times that a payment is made by the first payment application. Moreover, for example, time when a payment is possible by the second payment application 234 may be configured to be limited for a designated time from a point in time when the time is set in the memory such that the second payment information is sent to the external payment device 202.

Moreover, according to an embodiment of the present disclosure, in the case where a value corresponding to the power information is less than the power value, the second payment information may be set in the memory such that the second payment information is designated as default payment information. For example, in the case where the value corresponding to the power information is greater than or equal to the power value, the first payment information may be set in the memory such that the first payment information is designated as default payment information.

The payment method of the electronic device 201 according to various embodiments of the present disclosure may include verifying (or monitoring) the remaining power of the battery 211 included in the electronic device 201, configuring the (second) payment application 234, which does not require a user authentication, stored in the SE 230 of the electronic device 201 to be in a condition in which a payment is possible if the remaining power of the battery 211 is less than or equal to a designated value, and sending payment data, which is based on the (second) payment application configured to be in a condition in which the payment is possible, to the external payment device 202.

According to an embodiment of the present disclosure, if the remaining power of the battery 211 is greater than a designated value, the payment method of the electronic device 201 may further include configuring the (first) payment application 233, which requires a user authentication, stored in the SE 320 to be in a condition in which a payment is possible.

Moreover, according to an embodiment of the present disclosure, if the remaining power of the battery is less than or equal to a designated value, the electronic device 201 may configure the (second) payment application 234, which does not require a user authentication, to be in a condition in which a payment is possible after performing a separate user authentication.

Moreover, according to an embodiment of the present disclosure, the SE 230 may include at least one of an eSE, an UICC, an eUICC, a micro SD card, and a SIM card, and the user authentication may include at least one of a fingerprint authentication, a PIN authentication, or a biometric authentication. Moreover, the payment data may include, for example, at least one of a token, at least a part of a PAN, or a cryptogram.

Moreover, according to an embodiment of the present disclosure, the (first) payment application 233 requiring the user authentication and/or the (second) payment application 234 not requiring the user authentication may be configured to be in a condition, in which a payment is possible, based on a power supply from the auxiliary power module 213.

Moreover, according to an embodiment of the present disclosure, the (first) payment application requiring a user authentication and the (second) payment application not requiring a user authentication may be configured to be associated with the same financial account.

Moreover, according to an embodiment of the present disclosure, an amount of money available to pay by the (second) payment application not requiring a user authentication is configured to be smaller than an amount of money available to pay by the (first) payment application requiring a user authentication, and the number of times that a payment is made by the (second) payment application is configured to be smaller than the number of times that a payment is made by the (first) payment application. Time when a payment is possible by the (second) payment application not requiring a user authentication may be configured to be limited for a designated time from a point in time when the (second) payment application not requiring a user authentication is configured to be in the condition in which a payment is possible.

Moreover, according to an embodiment of the present disclosure, in the case where a value corresponding to the power information is less than a designated power value, the (second) payment application not requiring the user authentication may be designated as a default payment application. Moreover, for example, in the case where the value corresponding to the power information is greater than or equal to a designated power value, the (first) payment application requiring the user authentication may be designated as a default payment application.

According to various embodiments of the present disclosure, a payment method of the electronic device 201 may include verifying payment information of a power module (e.g., the battery 211) functionally connected to the electronic device 201, sending first payment information using a user authentication to the external payment device 240 in the case where the power information belongs to a first designated range, and sending second payment information not using a user authentication to an external payment device 202 in the case where the power information belongs to a second designated range.

According to an embodiment of the present disclosure, sending the first payment information or the second payment information to the external payment device 202 may be executed by using the power of the auxiliary power module 213 functionally connected with the electronic device 201.

For example, sending the first payment information or the second payment information to the external payment device 202 may be executed by using the power of the auxiliary power module 213 in the case where the power information of the power module belongs to the second designated range (e.g., in the case where the power module is suddenly discharged, in the case where the power module is removed from the electronic device 201, or the like).

According to an embodiment of the present disclosure, the payment method of the electronic device 201 may further include generating the first payment information and the second payment information based a piece of payment information.

According to an embodiment of the present disclosure, sending the first payment information or the second payment information to the external payment device 202 may include designating payment information, which is sent to the external payment device, from among the first payment information or the second payment information as default payment information.

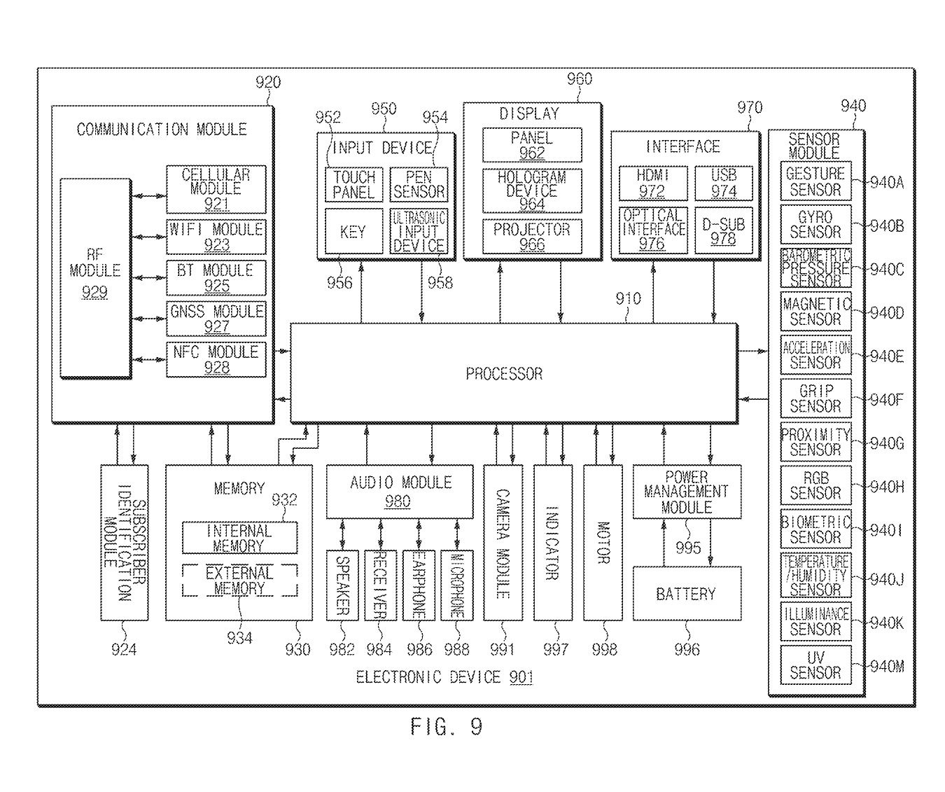

FIG. 9 illustrates a block diagram of an electronic device 901 according to various embodiments of the present disclosure.

Referring to FIG. 9, the electronic device 901 may include, for example, all or a part of an electronic device 201 illustrated in FIG. 101. Referring to FIG. 9, the electronic device 300 may include one or more AP 910, a communication module 920, a SIM card 924, a memory 930, a sensor module 940, an input device 950, a display 960, an interface 970, an audio module 980, a camera module 991, a power management module 995, a battery 996, an indicator 997, and a motor 998.

The AP 910 (e.g., the processor 220) may drive, for example, an OS or an application to control a plurality of hardware or software components connected to the AP 910 and may process and compute a variety of data including multimedia data. The AP 910 may be implemented with a system on chip (SoC), for example. According to an embodiment of the present disclosure, the AP 910 may further include a graphic processing unit (GPU) (not illustrated).

The communication module 920 may exchange data between the electronic device 901 and other electronic devices (e.g., the external payment device 202 of FIG. 2, the payment application server 203 of FIG. 2, and a mobile payment service server 204) connected through a network. According to an embodiment of the present disclosure, the communication module 920 may include a cellular module 921, a wireless-fidelity (Wi-Fi) module 923, a Bluetooth (BT) module 925, a GPS module 927, a NFC module 928, and a RF module 929. At least one of various examples of the communication module 920 may be included in, for example, the near-field wireless communication module 240, and/or the communication circuit 260.

The cellular module 921 may provide voice communication, video communication, a character service, an Internet service, or the like through a communication network (e.g., long-term evolution (LTE), LTE-advanced (LTE-A), code division multiple access (CDMA), wideband CDMS (WCDMA), universal mobile telecommunications system (UMTS), wireless broadband (WiBro), global system for mobile communications (GSM), or the like). Moreover, for example, the cellular module 921 may perform discrimination and authentication of the electronic device 901 within a communication network using a SIM (e.g., a SIM card 924). According to an embodiment of the present disclosure, the cellular module 921 may perform at least a part of functions that the AP 910 provides. For example, the cellular module 921 may perform at least a part of multimedia control functions.

According to an embodiment of the present disclosure, the cellular module 921 may include a communication processor (CP). Moreover, for example, the cellular module 921 may be implemented with a SOC. In FIG. 9, elements of the cellular module 921 (e.g., a CP), the memory 930, the power management module 995, or the like may be illustrated as elements that are independent of the AP 910. However, the AP 910 may be implemented to include at least a part (e.g., the cellular module 921) of the above-described elements.

According to an embodiment of the present disclosure, the AP 910 or the cellular module 921 (e.g., a CP) may load and process a command or data received from at least one of a nonvolatile memory or other elements connected to the AP 910 or the cellular module 921. Moreover, the AP 910 or the cellular module 921 may store data received from at least one of other elements or generated by at least one of other elements in a nonvolatile memory.

For example, each of the Wi-Fi module 923, the BT module 925, the GPS module 927, and the NFC module 928 (e.g., near-field wireless communication module 240 of FIG. 2) may include a processor (e.g., the NFC controller 241 of FIG. 2) for processing data exchanged through a corresponding module. In FIG. 9, each of the cellular module 921, the Wi-Fi module 923, the BT module 925, the GPS module 927, or the NFC module 928 is illustrated. However, according to various embodiments of the present disclosure, at least a part (e.g., two or more components) of the cellular module 921, the Wi-Fi module 923, the BT module 925, the GPS module 927, and the NFC module 928 may be included within one integrated circuit (IC) or an IC package. For example, at least a part (e.g., a CP corresponding to the cellular module 921 and a Wi-Fi processor corresponding to the Wi-Fi module 923) of processors corresponding to each of the cellular module 921, the Wi-Fi module 923, the BT module 925, the GPS module 927, or the NFC module 928 may be implemented with one SoC.

The RF module 929 (e.g., the RF module 242 of FIG. 2) may send and receive data (e.g., an RF signal). The RF module 929 that is not illustrated may include a transceiver, a power amplifier module (PAM), a frequency filter, low noise amplifier (LNA), an antenna, or the like. Moreover, the RF module 929 may further include a component (e.g., a conductor, a conducting wire, or the like) for sending and receiving an electromagnetic wave in a space based on a wireless communication. In FIG. 9, the cellular module 921, the Wi-Fi module 923, the BT module 925, the GPS module 927, and the NFC module 928 are illustrated as being shared with each other. However, according to various embodiments of the present disclosure, at least one of the cellular module 921, the Wi-Fi module 923, the BT module 925, the GPS module 927, or the NFC module 928 may send and receive an RF signal through a separate RF module.

The SIM card 924 (i.e., an example of the SE 230 illustrated in FIG. 2) may be a card including a SIM and may be inserted to a slot formed at a designated position in the electronic device. The SIM card 924 may include may include unique identification information (e.g., integrated circuit card identifier (ICCID)) or subscriber information (e.g., integrated mobile subscriber identity (IMSI)).

The memory 930 may include an internal memory 932 or an external memory 934. For example, the internal memory 932 may include at least one of a volatile memory (e.g., a dynamic random access memory (DRAM), a static RAM (SRAM), or a synchronous DRAM (SDRAM)), or a nonvolatile memory (e.g., a one-time programmable read only memory (OTPROM), a PROM, an erasable and programmable ROM (EPROM), an electrically erasable and programmable ROM (EEPROM), a mask ROM, a flash ROM, a NAND flash memory, a NOR flash memory, or the like).

According to an embodiment of the present disclosure, the internal memory 932 may be a solid state drive (SSD). The external memory 934 may include a flash drive, for example, a compact flash (CF), a SD, a micro SD, a mini SD, an extreme digital (xD), a memory stick, or the like. At least micro-SD in the external memory 934 may provide a function corresponding to the SE 230 illustrated in FIG. 2. The external memory 934 may be functionally connected to the electronic device 901 through various interfaces. According to an embodiment of the present disclosure, the electronic device 901 may further include a storage device (or storage medium) such as a hard drive.

The sensor module 940 may measure a physical quantity or may detect an operation state of the electronic device 901. The sensor module 340 may convert the measured or detected information to an electric signal. According to an embodiment of the present disclosure, the sensor module 940 may be composed of a part of the user authentication module 250 illustrated in FIG. 2. The sensor module 940 may include at least one of a gesture sensor 940A, a gyro sensor 940B, a barometric sensor 940C, a magnetic sensor 940D, an acceleration sensor 940E, a grip sensor 940F, a proximity sensor 940G, a color sensor 940H (e.g., red, green, blue (RGB) sensor), a biometric sensor 940I, a temperature/humidity sensor 940J, an illuminance sensor 940K, or an UV sensor 940M. Additionally or generally, for example, the sensor module 940 may be composed of at least a part of the user authentication module 250 illustrated in FIG. 2. For example, the sensor module 940 may include, for example, an E-nose sensor (not illustrated), an electromyography sensor (EMG) sensor (not illustrated), an electroencephalogram (EEG) sensor (not illustrated), an electrocardiogram (ECG) sensor (not illustrated), an infrared (IR) sensor (not illustrated), an iris sensor (not illustrated), a fingerprint sensor (not illustrated), or the like. The sensor module 940 may further include a control circuit for controlling at least one or more sensors included therein.

The input device 950 may include a touch panel 952, a (digital) pen sensor 954, a key 956, or an ultrasonic input unit 958. The touch pad 952 may detect a touch input based on at least one of capacitive, resistive, IR and ultrasonic detecting methods. Also, the touch panel 952 may further include a control circuit. In the case of a capacitive detecting method, a physical contact or proximity recognition may be possible. The touch panel 952 may further include a tactile layer. In this case, the touch panel 952 may provide a tactile reaction to a user.

The (digital) pen sensor 954 may be implemented using the same as or similar to receiving the touch input of a user or an additional sheet for recognition. The key 956 may include, for example, a physical button, an optical key, a keypad, and the like. The ultrasonic input device 958, which is an input device for generating an ultrasonic signal, may enable the electronic device 901 to sense a sound wave through a microphone (e.g., a microphone 988) so as to identify data. Moreover, in the ultrasonic input device 958, a wireless recognition may be possible. According to an embodiment of the present disclosure, the electronic device 901 may receive a user input from an external device (e.g., a computer or a server) connected with the electronic device 901 based on the communication module 920.

The display 960 may include a panel 962, a hologram device 964, or a projector 966. The panel 962 may be, for example, a liquid crystal display (LCD) panel, an active-matrix organic light-emitting diode (AM-OLED) panel, or the like. The panel 962 may be, for example, flexible, transparent or wearable. The panel 962 and the touch panel 952 may be integrated into a single module. The hologram device 964 may display a stereoscopic image in a space using a light interference phenomenon. The projector 966 may project light onto a screen so as to display an image. For example, the screen may be arranged in the inside or the outside of the electronic device 901. According to an embodiment of the present disclosure, the display module 960 may further include a control circuit for controlling the panel 962, the hologram device 964, or the projector 966.

The interface 970 may include, for example, a high-definition multimedia interface (HDMI) 972, a universal serial bus (USB) 974, an optical interface 976, or a D-subminiature (D-sub) 978. Additionally or alternatively, the interface 970 may include, for example, a mobile high definition link (MHL) interface, a SD card/multi-media card (MMC) interface, or an IR data association (IrDA) standard interface.

The audio module 980 may convert a sound and an electric signal in dual directions. The audio module 980 may process, for example, sound information that is input or output through a speaker 982, a receiver 984, an earphone 986, or a microphone 988.

The camera module 991 for shooting a still image or a video may include at least one image sensor (e.g., a front sensor or a rear sensor), a lens (not illustrated), an image signal processor (ISP) (not illustrated), or a flash (e.g., an LED or a xenon lamp) (not illustrated).

The power management module 995 (e.g., the power management module 212 of FIG. 2) may manage, for example, power of the electronic device 901. Although not illustrated, the power management module 995 may include, for example, a power management integrated circuit (PMIC) a charger IC, or a battery or fuel gauge.

The PMIC may be mounted in, for example, an integrated circuit or a SoC semiconductor. A charging manner may be classified into a wireless charging manner and a wired charging manner. The charging IC may charge a battery and may prevent over-voltage or over-current flows from a charger. According to an embodiment of the present disclosure, the charging IC may include a charging IC in at least one manner of a wireless charging manner or a wired charging manner. For example, a magnetic resonance method, a magnetic induction method or an electromagnetic method may be included in the wireless charging method, and an additional circuit for a wireless charging, for example, a coil loop, a resonant circuit, or a rectifier, and the like may be further added to the charging IC.

The battery gauge may measure, for example, the remaining capacity of the battery 996 and a voltage, current or temperature thereof while the battery is charged. The battery 996 may store and generate electricity and may power the electronic device 901 using the stored or generated electricity. The battery 996 may include, for example, a rechargeable battery or a solar battery.

The indicator 997 may display the fixed state of the electronic device 901 or a part thereof (e.g., the AP 910), such as a booting state, a message state, a charging state, and the like. The motor 998 may convert an electrical signal into a mechanical vibration. Although not illustrated, the electronic device 901 may include a processing device (e.g., a GPU) for supporting a mobile TV. The processing device for supporting the mobile TV may process, for example, media data according to the standards of digital multimedia broadcasting (DMB), digital video broadcasting (DVB), MediaFLO™, or the like.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other, forming one entity, so that the functions of the elements may be performed in the same manner as before the combination.

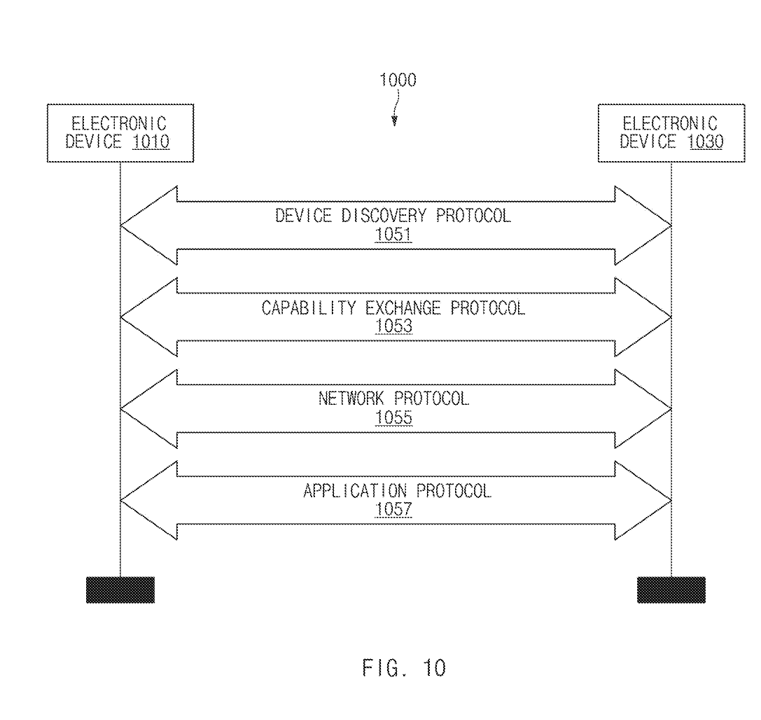

FIG. 10 illustrates a communication protocol between a plurality of electronic devices according to various embodiments of the present disclosure.

Referring to FIG. 10, for example, the communication protocol 1000 may include a device discovery protocol 1051, a capability exchange protocol 1053, a network protocol 1055, an application protocol 1057, and the like.

According to an embodiment of the present disclosure, the device discovery protocol 1051 may be a protocol for detecting an external electronic device, which is capable of communicating with the electronic devices (e.g., the electronic device 201 of FIG. 2, the external payment device 202 of FIG. 2, the payment application server 203 of FIG. 2, and a mobile payment service server 204), by the electronic devices or and connecting the electronic devices with the detected external electronic device. For example, the electronic device 1010 may be a device that communicates with the electronic device 1010 through a communication method (e.g., a Wi-Fi, a BT, a USB, or the like) used at the electronic device 1010 and may detect the electronic device 1030 (e.g., the external payment device 202 of FIG. 2, the payment application server 203 of FIG. 2, and a mobile payment service server 204) using the device discovery protocol 1051. For a communication connection with the electronic device 1030, the electronic device 1010 may obtain and store identification information about the detected electronic device 1030 based on the device discovery protocol 1051. The electronic device 1010 may establish, for example, the communication connection with the electronic device 1030 based on at least the identification information.

According to an embodiment of the present disclosure, the device discovery protocol 1051 may be a protocol for a mutual authentication between a plurality of electronic devices. For example, the electronic device 1010 may perform an authentication between the electronic device 1010 and the electronic device 1030 based on communication information (e.g., a media access control (MAC) address, a universally unique identifier (UUID), a subsystem identification (SSID), and an Internet protocol (IP) address) for a connection with the at least electronic device 1030.

According to an embodiment of the present disclosure, the capability exchange protocol 1053 may be a protocol for exchanging information associated with the function of a service that is supported by at least one of the electronic device 1010 or the electronic device 1030. For example, the electronic device 1010 and the electronic device 1030 may exchange information associated with the function of a service, which is provided by the electronic device 1010 or the electronic device 1030, through the capability exchange protocol 1053. Information that is exchangeable may include identification information indicating a specific service, which is supported by the electronic device 1010 and the electronic device 1030, from among a plurality of services. For example, the electronic device 1010 may receive the identification information of the specific service, which the electronic device 1030 provides, from the electronic device 1030 through the capability exchange protocol 1053. In this case, the electronic device 1010 may determine whether the electronic device 1010 supports the specific service, based on the received identification information.

According to an embodiment of the present disclosure, the network protocol 1055 may be a protocol for controlling a data flow between electronic devices connected to communicate with each other (e.g., for interworking with and providing a service). For example, at least one of the electronic device 1010 or the electronic device 1030 may perform an error control, a data quality control, or the like based on the network protocol 1055. Additionally or generally, the network protocol 1055 may determine a transmission format of data that is sent and received between the electronic device 1010 and the electronic device 1030. Moreover, at least one of the electronic device 1010 or the electronic device 1030 may manage (e.g., a session connection or session end) at least one session for exchanging data with each other based on the network protocol 1055.

According to an embodiment of the present disclosure, the application protocol 1057 may be a protocol for exchanging data associated with a service provided to an external electronic device and providing a process or information. For example, the electronic device 1010 may provide a service through the application protocol 1057.

According to an embodiment of the present disclosure, the communication protocol 1000 may include a standard communication protocol, a communication protocol (e.g., a communication protocol designated by a communication device manufacturer, a network provider, or the like) designated by a person or a group, or a combination thereof.

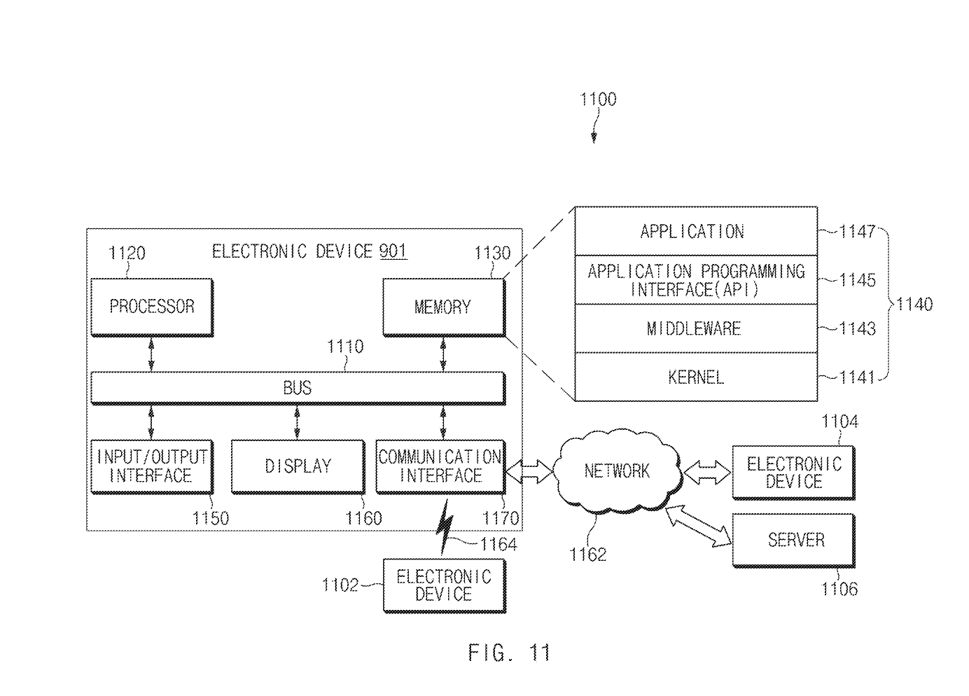

FIG. 11 illustrates an electronic device in a network environment according to various embodiments of the present disclosure.

Referring to FIG. 11, the electronic device 1100 (e.g., the electronic device 101 of FIG. 1, the electronic device 201 of FIG. 2, the electronic device 901 of FIG. 9, or the like) may include a bus 1110, a processor 1120, a memory 1130, an input/output interface 1150, a display 1160, and a communication interface 1170. According to an embodiment of the present disclosure, the electronic device 1100 may not include at least one of the above-described components or may further include other component(s).

For example, the bus 1110 may interconnect the above-described components 1110 to 970 and may be a circuit for conveying communications (e.g., a control message and/or data) among the above-described components.

The processor 1120 (e.g., the processor 202) may include one or more of a CPU, an AP, or a CP. For example, the processor 1120 may perform an arithmetic operation or data processing associated with control and/or communication of at least other components of the electronic device 1100.

The memory 1130 may include a volatile and/or nonvolatile memory. The memory 1130 may store instructions or data associated with at least one other component(s) of the electronic device 1100. According to an embodiment of the present disclosure, the memory 1130 may store software and/or a program 1140. The program 1140 may include, for example, a kernel 1141, a middleware 1143, an API 1145, and/or an application program (or an application) 1147. At least a part of the kernel 1141, the middleware 1143, or the API 1145 may be called an OS.

For example, the kernel 1141 may control or manage system resources (e.g., the bus 1110, the processor 1120, the memory 1130, and the like) that are used to execute operations or functions of other programs (e.g., the middleware 1143, the API 1145, and the application program 1147). Furthermore, the kernel 1141 may provide an interface that allows the middleware 1143, the API 1145, or the application program 1147 to access discrete components of the electronic device 1100 so as to control or manage system resources.

The middleware 1143 may perform a mediation role such that the API 1145 or the application program 1147 communicates with the kernel 1141 to exchange data.

Furthermore, the middleware 1143 may process task requests received from the application program 1147 according to a priority. For example, the middleware 1143 may assign the priority, which makes it possible to use a system resource (e.g., the bus 1110, the processor 1120, the memory 1130, or the like) of the electronic device 1100, to at least one of the application program 1147. For example, the middleware 1143 may process the one or more task requests according to the priority assigned to the at least one, which makes it possible to perform scheduling or load balancing on the one or more task requests.

The API 1145 may be, for example, an interface through which the application program 1147 controls a function provided by the kernel 1141 or the middleware 1143, and may include, for example, at least one interface or function e.g., an instruction for a file control, a window control, image processing, a character control, or the like.

The I/O interface 1150 may transmit an instruction or data, input from a user or another external device, to other component(s) of the electronic device 1100. Furthermore, the input/output interface 1150 may output an instruction or data, received from other component(s) of the electronic device 1100, to a user or another external device.

The display 1160 may include, for example, a LCD, a LED display, an OLED display, a microelectromechanical systems (MEMS) display, or an electronic paper display. The display 1160 may display, for example, various contents (e.g., a text, an image, a video, an icon, a symbol, and the like) to a user. The display 1160 may include a touch screen and may receive, for example, a touch, gesture, proximity, or hovering input using an electronic pen or a part of a user's body.

The communication interface 1170 (e.g., the communication module of FIG. 2) may establish communication between the electronic device 1100 and an external device (e.g., the external device 1102, the external electronic device 1104, or a server device 1106). For example, the communication interface 1170 may be connected to a network 1162 through wireless communication or wired communication to communicate with an external device (e.g., the second external electronic device 1104 or the server 1106).

The wireless communication may include at least one of, for example, a LTE, an LTE-A, a CDMA, a WCDMA, a UMTS, a WiBro, a GSM, or the like, as a cellular communication protocol. Furthermore, the wireless communication may include, for example, a local area network 1164. The local area network 1164 may include at least one of, for example, a Wi-Fi, a BT, a NFC, a global navigation satellite system (GNSS), or the like. The GNSS may include at least one of a GPS, a global navigation satellite system (Glonass), Beidou Navigation Satellite System (hereinafter referred to as “Beidou”), or the European global satellite-based navigation system (Galileo). In this specification, “GPS” and “GNSS” may be interchangeably used. The wired communication may include at least one of, for example, a USB, a HDMI, a recommended standard-232 (RS-232), a plain old telephone service (POTS), or the like. The network 1162 may include at least one of telecommunications networks, for example, a computer network (e.g., local area network (LAN) or wide area network (WAN)), an Internet, or a telephone network.

Each of the first and second external electronic devices 1102 and 1104 may be a device of which the type is the same as that of the electronic device 1100 (e.g., the electronic device 201) or another type of device (e.g., the external payment device 202). According to an embodiment of the present disclosure, the server 1106 (e.g., the payment application server 203 and the mobile payment service server 204) may include a group of one or more servers. According to various embodiments of the present disclosure, all or a part of operations that the electronic device 1100 will perform may be executed by another or plural electronic devices (e.g., the electronic devices 1102 and 1104 or the server 1106). According to an embodiment of the present disclosure, in the case where the electronic device 1100 executes any function or service automatically or in response to a request, the electronic device 1100 may not execute the function or the service internally, but, alternatively additionally, it may request at least a part of a function associated with the electronic device 101 at other devices (e.g., the electronic devices 1102 and 1104 or the server device 1106). The other electronic device (e.g., the electronic device 1102 or 1104 or the server 1106) may execute the requested function or additional function and may transmit the execution result to the electronic device 1100. The electronic device 1100 may provide the requested function or service using the received result or may additionally process the received result to provide the requested function or service. To this end, for example, cloud computing, distributed computing, or client-server computing may be used.

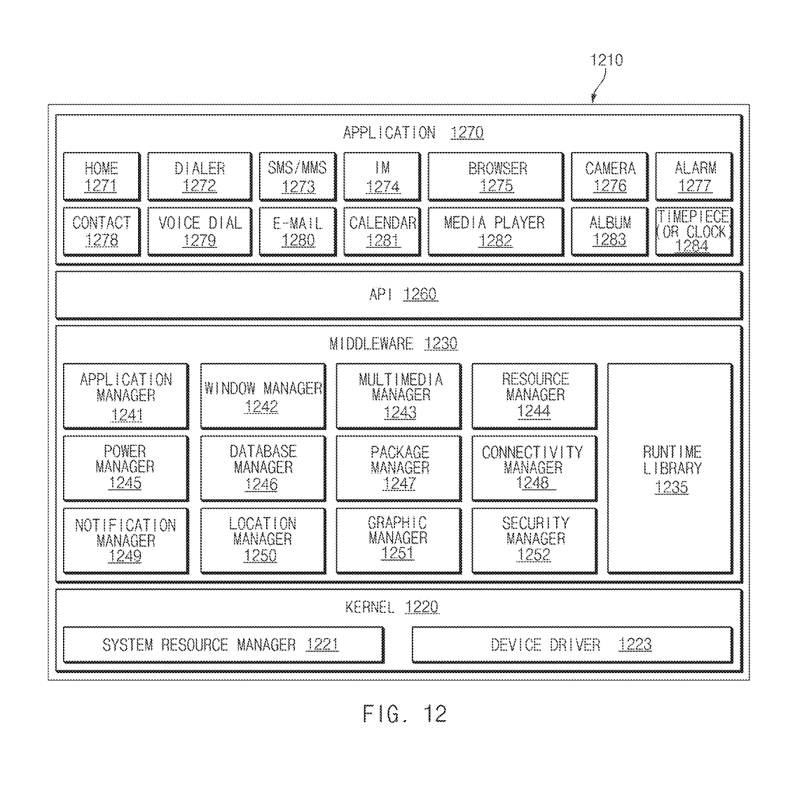

FIG. 12 illustrates a block diagram of a program module according to various embodiments of the present disclosure.

Referring to FIG. 12, a program module 1210 (e.g., a program 1140 of FIG. 11) may include an OS to control resources associated with an electronic device (e.g., the electronic device 201), and/or diverse applications (e.g., the application program 1147) driven on the OS. The OS may be, for example, Android™, iOS™, Windows™, Symbian™, Tizen™, or Samsung bada OS™.

The program module 1210 may include a kernel 1220, a middleware 1230, an API 1260, and/or an application 1270. At least a part of the program module 1210 may be preloaded on an electronic device or may be downloadable from an external electronic device (e.g., the electronic devices 1102 and 1104, the server 1106, and the like).

The kernel 1220 (e.g., the kernel 1141) may include, for example, a system resource manager 1221 or a device driver 1223. The system resource manager 1221 may perform control, allocation, or retrieval of system resources. According to an embodiment of the present disclosure, the system resource manager 1221 may include a process managing part, a memory managing part, or a file system managing part. The device driver 1223 may include, for example, a display driver, a camera driver, a BT driver, a common memory driver, an USB driver, a keypad driver, a Wi-Fi driver, an audio driver, or an inter-process communication (IPC) driver.

The middleware 1230 may provide, for example, a function which the application 1270 needs in common, or may provide diverse functions to the application 1270 through the API 1260 to allow the application 1270 to efficiently use limited system resources of the electronic device. According to an embodiment of the present disclosure, the middleware 1230 (e.g., the middleware 1143) may include at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, or a security manager 1252.

The runtime library 1235 may include, for example, a library module which is used by a compiler to add a new function through a programming language while the application 1270 is being executed. The runtime library 1235 may perform input/output management, memory management, or capacities about arithmetic functions.

The application manager 1241 may manage, for example, a life cycle of at least one application of the application 1270. The window manager 1242 may manage a GUI resource which is used in a screen. The multimedia manager 1243 may identify a format necessary for playing diverse media files, and may perform encoding or decoding of media files by using a codec suitable for the format. The resource manager 1244 may manage resources such as a storage space, memory, or source code of at least one application of the application 1270.

The power manager 211 (e.g., including the payment management module 211 of FIG. 2) may operate, for example, with a basic input/output system (BIOS) to manage a battery or power, and may provide power information for an operation of an electronic device. The database manager 1246 may generate, search for, or modify database which is to be used in at least one application of the application 1270. The package manager 1247 may install or update an application which is distributed in the form of package file.

The connectivity manager 1248 may manage, for example, wireless connection such as Wi-Fi or BT. The notification manager 1249 may display or notify an event such as arrival message, promise, or proximity notification in a mode that does not disturb a user. The location manager 1250 may manage location information of an electronic device. The graphic manager 1251 may manage a graphic effect that is provided to a user, or manage a user interface relevant thereto. The security manager 1252 may provide a general security function necessary for system security or user authentication. According to an embodiment of the present disclosure, in the case where an electronic device (e.g., the electronic device 1100) includes a telephony function, the middleware 1230 may further includes a telephony manager for managing a voice or video call function of the electronic device.

The middleware 1230 may include a middleware module that combines diverse functions of the above-described components. The middleware 1230 may provide a module specialized to each OS kind to provide differentiated functions. Additionally, the middleware 1230 may remove a part of the preexisting components, dynamically, or may add a new component thereto.

The API 1260 (e.g., an API 1260) may be, for example, a set of programming functions and may be provided with another configuration which is variable depending on an OS. For example, in the case where an OS is the android or the iOS, it may be permissible to provide one API set per platform. In the case where an OS is the tizen, it may be permissible to provide two or more API sets per platform.

The application 1270 (e.g., the application program 1147) may include, for example, one or more applications capable of providing functions for a home 1271, a dialer 1272, an SMS/multimedia messaging service (MMS) 1273, an instant message (IM) 1274, a browser 1275, a camera 1276, an alarm 1277, a contact 1278, a voice dial 1279, an e-mail 1280, a calendar 1281, a media player 1282, am album 1283, and a timepiece 1284, or for offering health care (e.g., measuring an exercise quantity or blood sugar) or environment information (e.g., atmospheric pressure, humidity, or temperature).

According to an embodiment of the present disclosure, the application 1270 may include an application (hereinafter referred to as “information exchanging application” for descriptive convenience) to support information exchange between the electronic device (e.g., the electronic device 1100) and an external electronic device (e.g., the electronic device 1102 or 1104). The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., an electronic device 1102 or 1104). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device (e.g., the electronic device 1102 or 1104) which communicates with the electronic device, an application running in the external electronic device, or a service (e.g., a call service, a message service, or the like) provided from the external electronic device.

According to an embodiment of the present disclosure, the application 1270 may include an application (e.g., a health care application of a mobile medical device, and the like) which is assigned in accordance with an attribute of the external electronic device (e.g., the electronic device 1102 or 1104). According to an embodiment of the present disclosure, the application 1270 may include an application which is received from an external electronic device (e.g., the server 1106 or the electronic device 1102 or 1104). According to an embodiment of the present disclosure, the application 1270 may include a preloaded application or a third party application which is downloadable from a server. The component titles of the program module 1210 according to the embodiment of the present disclosure may be modifiable depending on kinds of OSs.

According to various embodiments of the present disclosure, at least a part of the program module 1210 may be implemented by software, firmware, hardware, or a combination of two or more thereof. At least a part of the program module 1210 may be implemented (e.g., executed), for example, by a processor (e.g., the processor 220). At least a part of the program module 1210 may include, for example, modules, programs, routines, sets of instructions, or processes, or the like for executing one or more functions.

The term “module” used according to various embodiments of the present disclosure may represent, for example, a unit including one or more combinations of hardware, software and firmware. For example, the term “module” may be interchangeably used with the terms “unit”, “logic”, “logical block”, “component” and “circuit”. The “module” may be a minimum unit of an integrated component or may be a part thereof. The “module” may be a minimum unit for executing one or more functions or a part thereof. The “module” may be implemented mechanically or electronically. For example, the “module” according to various embodiments of the present disclosure may include at least one of an application-specific IC (ASIC) chip, a field-programmable gate array (FPGA), and a programmable-logic device for performing some operations, which are known or will be developed.

According to various embodiments of the present disclosure, at least a portion of an apparatus (e.g., modules or functions thereof) or a method (e.g., operations) according to various embodiments of the present disclosure may be, for example, implemented by instructions stored in a non-transitory computer-readable storage media in the form of a programming module. The instruction, when executed by one or more processors (e.g., the processor 220 of FIG. 2), may cause the one or more processors to perform a function corresponding to the instruction. The non-transitory computer-readable storage media, for example, may be a memory. At least a portion of the programming module may be implemented (e.g., executed), for example, by the processor 220. At least a portion of the programming module may include, for example, a module, a program, a routine, sets of instructions, or a process for executing one or more functions.

The non-transitory computer-readable storage media may include a hard disk, a magnetic media (e.g., a floppy disk and a magnetic tape), an optical media (e.g., a compact disc read only memory (CD-ROM) and a DVD), a magneto-optical media (e.g., a floptical disk), and hardware devices (e.g., a ROM, a RAM, or a flash memory) that are specially configured to store and execute program instructions (e.g., the programming module). Also, a program instruction may include not only a mechanical code such as things generated by a compiler but also a high-level language code executable on a computer using an interpreter. The above-mentioned hardware devices may be configured to operate as one or more software modules to perform operations according to various embodiments of the present disclosure, and vice versa.

Modules or programming modules according to various embodiments of the present disclosure may include at least one or more of the above-mentioned elements, some of the above-mentioned elements may be omitted, or other additional elements may be further included therein. Operations executed by modules, programming modules, or other elements may be executed by a successive method, a parallel method, a repeated method, or a heuristic method. Also, a part of operations may be executed in different sequences, omitted, or other operations may be added.

According to various embodiments of the present disclosure, in a storage media storing instructions, when the instructions are executed by at least one processor, the at least one processor is configured to perform at least one operation. The at least one operation may include obtaining payment information of a power module (e.g., the battery 211) functionally connected to the electronic device 201, setting a memory (e.g., the SE 230) such that a first payment information using a user authentication is sent to the external payment device 202 in the case where a value corresponding to the power information is greater than or equal to a designated power value, and setting the memory such that a second payment information not using a user authentication is sent to an external payment device 202 in the case where the value corresponding to the power information is smaller than a designated power value.

Moreover, according to various embodiments of the present disclosure, in a storage media storing instructions, when the instructions are executed by at least one processor, the at least one processor is configured to perform at least one operation. The at least one operation may include verifying payment information of a power module (e.g., the battery 211) functionally connected to the electronic device 201, sending first payment information using a user authentication to the external payment device 240 in the case where the power information belongs to a first designated range, and sending second payment information not using a user authentication to an external payment device 202 in the case where the power information belongs to a second designated range.

Moreover, according to various embodiments of the present disclosure, in a storage media storing instructions, when the instructions are executed by at least one processor, the at least one processor is configured to perform at least one operation. The at least one operation may include verifying the remaining power of the battery 211 included in the electronic device 201, configuring a payment application, not requiring a user authentication, store in the SE 230 of the electronic device 201 to be in a condition in which a payment is possible if the remaining power of the battery 211 is smaller than or equal to a designated value, and sending payment data, which is based on the payment application configured to be in the condition in which the payment is possible, to the external payment device 202.

According to various embodiments of the present disclosure, in the case where an embedded battery does not have an enough power to perform a user authentication, a second payment application, which does not require a user authentication, stored in a SE may be configured to be in a condition in which a payment is possible. According to various embodiments of the present disclosure, the electronic device may make a mobile payment with an external payment device even though an embedded battery does not have an enough power to perform a user authentication or is powered off.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device that makes a payment with an external payment device, the electronic device comprising:
a power module configured to power the electronic device;
a memory configured to store first payment information that accompanies a user authentication and second payment information that does not accompany the user authentication;
a near-field wireless communication module configured to send the first payment information or the second payment information stored in the memory to the external payment device; and
a processor configured to:
obtain power information of the power module,
set the memory such that the first payment information is sent to the external payment device if a value corresponding to the power information is greater than or equal to a power value, and
set the memory such that the second payment information is sent to the external payment device if the value corresponding to the power information is less than the power value.

2. The electronic device of claim 1, wherein the processor corresponds to an application processor (AP) implemented independently of the near-field wireless communication module.

3. The electronic device of claim 1, wherein the memory comprises at least one of an embedded SE (eSE), a universal IC card (UICC), an embedded UICC (eUICC), a micro secure digital (SD) card, or a subscriber identification module (SIM) card.

4. The electronic device of claim 1, wherein the user authentication comprises at least one of a fingerprint authentication, a personal identification number (PIN) authentication, or a biometric authentication.

5. The electronic device of claim 1, further comprising:
an auxiliary power module configured to preparatorily power the electronic device,
wherein the processor is configured to set the memory such that the first payment information or the second payment information is sent to the external payment device based on power that the auxiliary power module supplies.

6. The electronic device of claim 1, wherein the first payment information or the second payment information is configured to be associated with the same financial account.

7. The electronic device of claim 1, wherein, if the value corresponding to the power information is less than the power value, the processor is configured to set the memory such that the second payment information is designated as default payment information.

8. The electronic device of claim 1, wherein, if the value corresponding to the power information is greater than or equal to the power value, the processor is configured to set the memory such that the first payment information is designated as default payment information.

9. An electronic device that makes a payment with an external payment device, the electronic device comprising:
a battery configured to power the electronic device;
a secure element (SE) configured to store a first payment application requiring a user authentication and a second payment application not requiring the user authentication;
a processor configured to configure the second payment application stored in the SE to be in a condition in which a payment is possible if remaining power of the battery is less than or equal to a value; and
a near-field wireless communication module configured to send payment information, which is based on the second payment application, to the external payment device.

10. The electronic device of claim 9, wherein the processor is configured to configure the first payment application stored in the SE to be in a condition in which a payment is possible if the remaining power of the battery is greater than the value.

11. The electronic device of claim 9, wherein the SE comprises a proximity payment system environment (PPSE), and
wherein the processor is configured to configure the second payment application to be in a condition in which a payment is possible by registering an application identifier (AID) of the second payment application in the PPSE.

12. The electronic device of claim 11, wherein the near-field wireless communication module is configured to:
establish a security channel with the external payment device based on the AID of the second payment application registered in the PPSE, and
send the payment data through the established security channel.

13. The electronic device of claim 9, wherein the payment data comprises at least one of a token, at least a part of a primary account number (PAN), or a cryptogram.

14. The electronic device of claim 9, wherein an amount of money available to pay by the second payment application is configured to be smaller than an amount of money available to pay by the first payment application or a number of times that a payment is made by the second payment application is configured to be smaller than a number of times that a payment is made by the first payment application.

15. The electronic device of claim 9, wherein time when a payment is possible by the second payment application is configured to be limited for a time from a point in time when the second payment application is configured to be in the condition in which a payment is possible.

16. The electronic device of claim 9, wherein, if the remaining power of the battery is less than or equal to a value, the processor is configured to configure the second payment application to be in a condition in which a payment is possible after performing the user authentication.

17. An electronic device comprising:
a memory configured to store first payment information that accompanies authentication information and second payment information that does not accompany the authentication information;
a near-field wireless communication module configured to send the first payment information or the second payment information to an external payment device; and
a payment management module situated outside the near-field wireless communication module,
wherein the payment management module is configured to:
verify power information of a power module functionally connected with the electronic device,
send the first payment information to the external payment device through the near-field wireless communication module if the power information belongs to a first range, and
send the second payment information to the external payment device through the near-field wireless communication module if the power information belongs to a second range.

18. The electronic device of claim 17, wherein the first range is comprised in a range in which a value corresponding to the power information is greater than or equal to a threshold value, and
wherein the second range is comprised in a range in which the value corresponding to the power information is less than the threshold value.

19. The electronic device of claim 17, further comprising:
an auxiliary power module,
wherein the payment management module is configured to send the first payment information or the second payment information to the external payment device by using the auxiliary power module.

20. The electronic device of claim 19, wherein the payment management module is configured to use the auxiliary power module if the power information belongs to the second range.
